(19) United States
(12) Patent Application Publication
(10) Pub. No.: US 2017/0053207 A1
(43) Pub. Date: Feb. 23, 2017

(54) Architecture Model-Based Interoperability Assessment

(71) Applicant: United States of America, as represented by the Seretary of the Navy, Arlington, VA (US)

(72) Inventor: Kristin M. GIAMMARCO, Nottingham, PA (US)

(21) Appl. No.: 14/247,657

(22) Filed: Apr. 8, 2014

Related U.S. Application Data
(60) Provisional application No. 61/813,421, filed on Apr. 18, 2013.

(51) Int. Cl. G06N 5/04

(52) U.S. Cl. CPC G06N 5/04

(57) ABSTRACT

A process for conducting architecture model-based interoperability assessment may reduce interoperability issues in a design. For instance, a computer-implemented method may include organizing, by a computing system, candidate conditions into a hierarchy of logical expressions, and determining, by the computing system, whether each child condition is necessary or unnecessary to its parent condition.

### CROSS REFERENCE TO RELATED APPLICATION

This application claims the benefit of U.S. Provisional Application Ser. No. 61/813,421, filed on Apr. 18, 2013. The subject matter of this earlier filed application is hereby incorporated by reference in its entirety.

### FIELD

The present invention generally relates to software interoperability, and more particularly, to a process for conducting architecture model-based interoperability assessments.

### BACKGROUND

In both the public and private sectors, systems engineering analysis studies are used to inform a range of decisions, from selecting among low level design alternatives to conducting high level portfolio management. Such studies are conducted to help various stakeholders make and justify decisions that have lasting effects on a system throughout its lifecycle. The quality of system models that are created and used to support these types of analyses can have a strong influence on the outcome of the decisions and ultimately on the success of the system.

Some of the most challenging problems to assess using system models involve stakeholder expressions for needs that are nonfunctional in nature—qualities that apply to the whole system, such as operational effectiveness, security, resiliency, interoperability, safety, reliability, and sustainability. Interoperability is the ability of a performer to exchange resources with one or more other performers and to use those resources to accomplish its performed activities according to expected criteria.

Interoperability problems in a design can result in consequences that range from the inconvenient to the catastrophic. Interoperability problems continue to arise among deployed systems in their operating environments. Interoperability issues that crop up post-deployment are often resolved, if they can be resolved at all, through retrospective analysis of the design and ad hoc fixes. However, in today's increasingly complex acquisition environment, these after-the-fact processes are not sufficient long term solutions, are of limited utility after damage is done caused by the lack of interoperability, and may inhibit the development of more desired performance outcomes in a future design. Given the current environment of continuous technology insertion, the expectations for interoperability among current and future systems, and the cost of correcting interoperability problems post-deployment, an improved method for identifying and addressing specific system design issues early in the lifecycle may be beneficial.

### SUMMARY

Certain embodiments of the present invention may provide solutions to the problems and needs in the art that have not yet been fully identified, appreciated, or solved by current interoperability assessment systems. For example, embodiments described herein focus on a specific direction from the outset involving the decomposition of a system into performers, which are fundamental system elements that perform activities. Performers are the tangible, elementary objects in the architecture with which interoperability expectations are ultimately associated. To achieve system level interoperability, performers are designed such that the performers are connected, and behave, in an interoperable manner.

In one embodiment, a computer-implemented method includes organizing, by a computing system, candidate conditions into a hierarchy of logical expressions and determining, by the computing system, whether each child condition is necessary or unnecessary to its parent condition.

In another embodiment, a computer-implemented method includes receiving, by a computing system, an identified use case in an architecture model for interoperability assessment. The computer-implemented method also includes organizing, by the computing system, candidate conditions into a hierarchy of logical expressions, and determining, by the computing system, whether each child condition is necessary or unnecessary to a condition of a parent.

In yet another embodiment, a computer-implemented method includes receiving, by a computing system, a first performer and a second performer to determine interoperability between the first performer and the second performer in a design. The computer-implemented method also includes assessing, by the computing system, interoperability between the first performer and the second performer in the design, and transmitting, from the computing system, results of the assessment for the interoperability.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a flow diagram illustrating an AMBIA process, according to an embodiment of the present invention.

FIG. 2 is an architecture model illustrating an object-oriented conceptual data model (CDM), according to an embodiment of the present invention.

FIG. 3 is a block diagram illustrating a computing system for executing the AMBIA process, according to an embodiment of the present invention.

FIG. 4 is a diagram illustrating a use case for the AMBIA process, according to an embodiment of the present invention.

FIG. 5 is a diagram illustrating a data model subset, according to an embodiment of the present invention.

FIG. 6 illustrates an alloy model including a notional format used in the AMBIA process, according to an embodiment of the present invention.

FIG. 7 is a graph illustrating a metamodel, according to an embodiment of the present invention.

FIG. 8 is a graph illustrating an instance, according to an embodiment of the present invention.

FIG. 9 illustrates an updated metamodel, according to an embodiment of the present invention.

FIG. 10 is a graphical user interface illustrating a counterexample for an assertion, according to an embodiment of the present invention.

FIG. 11 is a graphical user interface illustrating a counterexample for a second assertion, according to an embodiment of the present invention.

FIG. 12 is a graph illustrating necessary conditions for an assertion, according to an embodiment of the present invention.

FIG. 13 is a diagram illustrating a data model subset 1, according to an embodiment of the present invention.

FIG. 14 illustrates an alloy model for an assertion of axiomatic conditions in model M′, according to an embodiment of the present invention.

FIGS. 15-17 are graphical user interfaces illustrating counterexamples for necessary conditions, according to an embodiment of the present invention.

FIG. 18 is a graph illustrating necessary conditions in model M′, according to an embodiment of the present invention.

FIG. 19 is a diagram illustrating a data model subset 2, according to an embodiment of the present invention.

FIG. 20 illustrates an alloy model for an assertion of axiomatic condition in model M″, according to an embodiment of the present invention.

FIG. 21 is a graph illustrating counterexamples for a necessary condition, according to an embodiment of the present invention.

FIG. 22 is a graph illustrating necessary condition in model M″, according to an embodiment of the present invention.

FIG. 23 is a diagram illustrating a data model subset 3, according to an embodiment of the present invention.

FIG. 24 illustrates an alloy model for an assertion of axiomatic conditions for model M″, according to an embodiment of the present invention.

FIGS. 25 and 26 are graphs illustrating counterexamples for a necessary condition, according to an embodiment of the present invention.

FIG. 27 is a graph illustrating a counterexample for a necessary condition, according to an embodiment of the present invention.

FIG. 28 is a graph illustrating a necessary condition for model M″, according to an embodiment of the present invention.

FIG. 29 is a graph illustrating all necessary conditions, according to an embodiment of the present invention.

### DETAILED DESCRIPTION OF THE EMBODIMENTS

Embodiments discussed herein provide architects and designers early assistance in identifying and correcting oversights in their designs that can potentially affect actual interoperability in a real software-intensive system or system of systems, and allow the prediction of many avoidable interoperability deficiencies well before deployment. In particular, certain embodiments pertain to a model-based method for assessing interoperability of a design represented in an architecture model, herein referred to as the Architecture Model-Based Interoperability Assessment (AMBIA) method.

AMBIA uses expressions based on a structured CDM of elements and relationships. This data model provides an unambiguous foundation for the formal specification of conditions for interoperability between pairs of performers in an architecture model. AMBIA is consistent with the existing model-based systems engineering concept of stepwise refinement of the architecture model. That is, AMBIA can be applied at different levels of abstraction, working equally well for high-level architecture model elements and for the low-level design elements into which they are decomposed. Thus, AMBIA can be applied in the earliest stages of design, before detailed work begins, and be progressively applied at increasing levels of design detail as the architecture model is decomposed.

AMBIA includes steps to develop a scoped data model containing classes and relationships that are relevant to interoperability assessment, documenting axioms that codify experience with interoperability deficiencies, deriving a set of conditions for interoperability from those classes and relationships, validating the necessity of those conditions to interoperability of a design, and applying the necessary conditions to an architecture model that conforms to the conceptual data model identified in the first step.

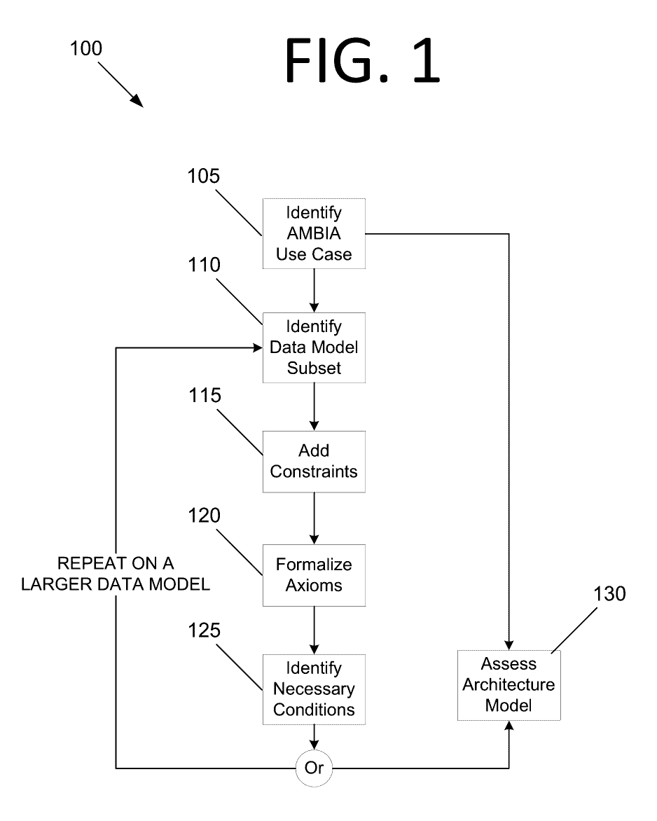

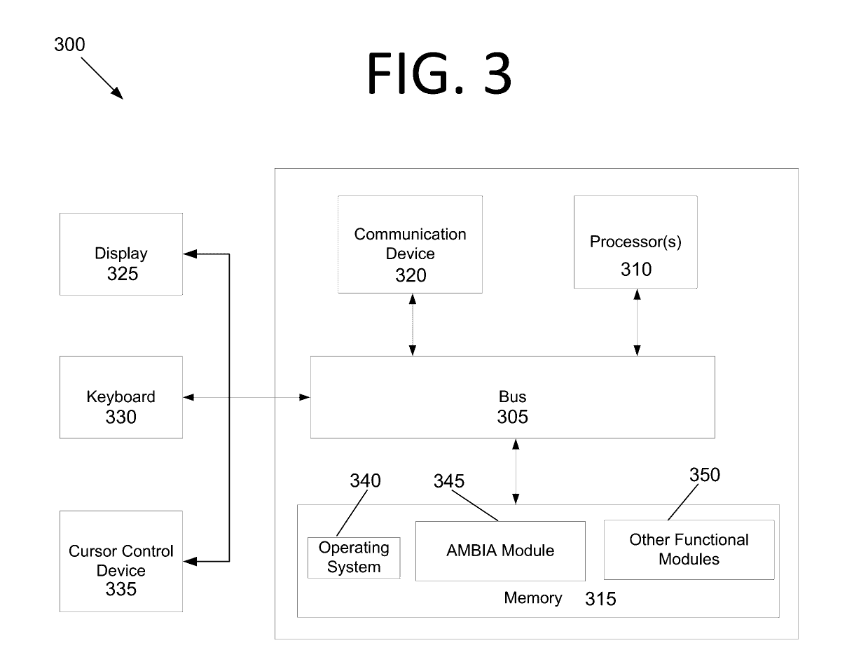

FIG. 1 is a flow diagram 100 illustrating an AMBIA process, according to an embodiment of the present invention. The computing system shown in FIG. 3, for example, may execute the AMBIA process of FIG. 1 in some embodiments.

In this embodiment, an AMBIA use case is identified, i.e., a problem is defined, at 105. At 110, a data model subset is identified, i.e., identification of architecture model classes and relationships among those classes that impact the design with respect to interoperability. Architecture model classes may include performer, activity, resource, connector, rule, and others.

At 115, constraints are added to the data model subset. For instance, a model of the relevant classes and relationships from step 110 may be built using relational logic, and constraints may be added to exclude instances that exhibit a poor general design practice, and/or may prevent interoperability for a given use case. In certain embodiments, a model-building tool may be used codify the CDM, and then examine the CDM over many different possible design instances (e.g., numbers and combinations of architecture model elements and relationships) to seek out properties that contradict interoperability of a design. This activity of condition discovery assists an individual to recall and document experience with interoperability deficiencies, and is based on how an individual or a community of stakeholders defines interoperability in unambiguous terms with respect to architecture model elements and relationships.

As more “non-interoperable” characteristics are found, constraints are written to prevent instances of design that exhibit the non-interoperable characteristics. If any of the conditions based on the constraints fail to hold true for an assessed design, then that design is not considered interoperable. It should also be appreciated that during this step, impractical (and, consequentially, distracting) design instances having nothing to do with interoperability may also be filtered out and separately documented as potential conditions for assessing other model qualities.

At 120, axioms are formalized, i.e., a set of axioms for non-interoperability of a design are summarized from the condition discovery process in step 115. These axioms can later be used to formulate assertions against which conditions will be tested for necessity for interoperability of a design. The axioms generated during this step may be the results of human observations and experience and the condition discovery process.

At 125, necessary conditions are identified, i.e., the new constraints necessary for interoperability of the design are determined, and all constraints are categorized and documented. In some embodiments, a list of axioms from a given implementation of AMBIA is used to formulate an assertion, and one condition at a time is removed from the data model subset while checking to see whether the assertion is still valid in each case. When the assertion is valid, there is no dependency on the removed condition. When the assertion is not valid, then there is a dependency and the condition may be necessary. In some embodiments, each condition is tested against every other condition to see whether there is an implication relationship to reveal necessary conditions.

The process then returns to step 110 to repeat the AMBIA process on a larger data model. For example, if another implementation is desired to expand the data model subset, the approach is repeated on more classes and relationships previously excluded from the scope of analysis. This iteration enables an incremental approach to defining conditions for interoperability of a design. Whereas it is currently impractical to assert that a set of conditions are sufficient for interoperability due to the myriad unknown influences, it is achievable in the near term to assert that a set of conditions are necessary for interoperability. This approach allows for a systematic process for building up the list of necessary conditions for interoperability of a design.

The process may also continue to 130 to assess an architecture model. For example, in this step, the necessary conditions for interoperability is applied to a target architecture model for analysis. In parallel with, or instead of, step 125, the conditions may be applied to a data set from a real, populated architecture model whose elements and relationships map to those of the CDM defined in step 105.

The AMBIA process described above allows for expansion and refinement of the interoperability assessment model (i.e., the conceptual data model+necessary conditions) as more is learned about what aspects of architecture models influence interoperability.

The steps performed in FIG. 1 may be performed by a computer program, encoding instructions for the nonlinear adaptive processor to perform at least the process described in FIG. 1, in accordance with embodiments of the present invention. The computer program may be embodied on a non-transitory computer-readable medium. The computer-readable medium may be, but is not limited to, a hard disk drive, a flash device, a random access memory, a tape, or any other such medium used to store data. The computer program may include encoded instructions for controlling the nonlinear adaptive processor to implement the process described in FIG. 1, which may also be stored on the computer-readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, in a cloud-based computing environment, or an application specific integrated circuit (ASIC).

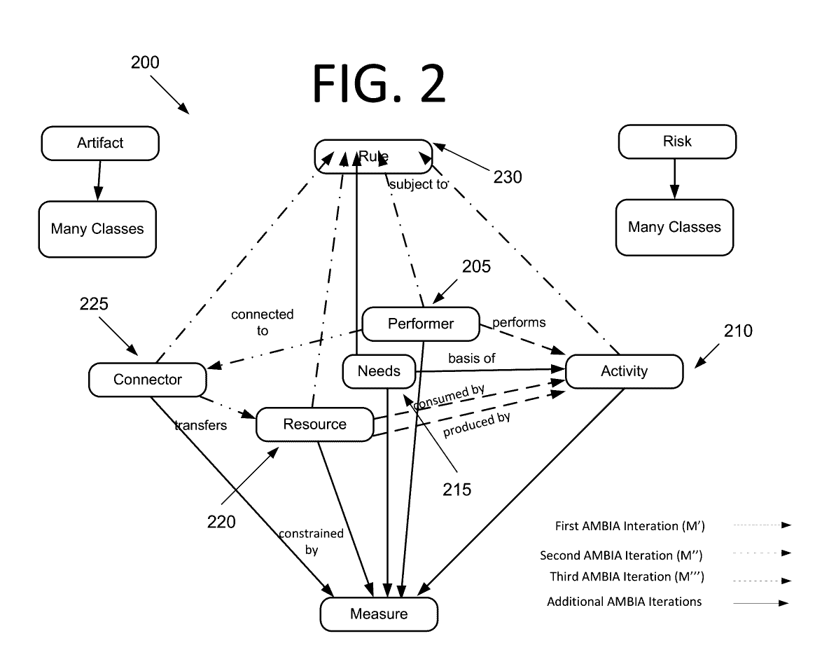

FIG. 2 is an architecture model 200 illustrating an object-oriented CDM, according to an embodiment of the present invention. Understanding and speaking a language of CDM helps architects and other stakeholders understand where the different pieces of a system fit, even the architects and stakeholders are not subject matter experts on the particular system being modeled. In architecture model 200, elements are used as abstract representations of a “real thing”. In architecture model 200, performer 205 performs an activity 210 based on a need 215 and produces or consumes a resource 220. Resource 220 is transferred by connector 225 that connect to performer 205. It should be readily appreciated that any element can be subject to a rule, constrained by a measure, or have an artifact or risk element. This CDM shown in FIG. 2 is one embodiment, and can be expanded in other embodiments.

In this embodiment, a CDM of classes (boxes) and relationships (lines) are based on Department of Defense Architecture Framework (DoDAF) 2.0, but may be extended to use the Unified Profile for DoDAF and Ministry of Defense Architecture Framework (MoDAF UPDM) concept. For example, classes are present for representing different types of information that would be documented in architecture model 200. The classes and relationships are considered to be significant concepts in the DoDAF, and the highlighted class and relationships between connector 225 and rule 230, resource 220, and performer 205 are UPDM-inspired additions to the DoDAF schema.

This schema can be used to describe a system under design in plentiful detail, providing placeholders for most kinds of data. For example, capabilities are used to describe needs that achieve desired effects. Behaviors of a system are described by activities that consume and produce resources under certain conditions. Rules (e.g., standards, agreements, etc.) constrain various elements, and measures apply to most elements.

The CDM is a model of models—the core abstraction of architecture models themselves. Any architecture model that is compliant with the DoDAF metal model (DM2) may include elements and relationships that closely match those in FIG. 2. Since many architecture models map to this schema or similar schemas, the CDM shown in FIG. 2 serves as the foundational model for interoperability assessment, and is referred to as model M. The classes and relationships in model M will be further defined and examined for their pertinence to interoperability below.

A perfect model of interoperability may contain a description of every possible interoperability condition for a system. This sort of model could require a great deal of experience from many systems in order to discover the information needed to build the model, and still there would be no way to definitively know for certain when all possible failure modes for interoperability in general have been found. Embodiments described herein pertain to a structured and repeatable method that allows a list of necessary conditions for interoperability to be cumulatively grown when new interoperability issues are discovered and formalized. Such an approach can be used to systematically and gradually document interoperability design flaws over time as they become known, in formal and abstract terms that can be applied to designs described by a data model compatible with the one used to generate the conditions. The foundation of this process is a theory of necessary conditions for interoperability of a design. The theory structures the necessary conditions for interoperability into two hierarchical levels. The second-level necessary conditions are root conditions formalized during a given implementation of the AMBIA process. These second-level conditions are aggregated into first-level necessary conditions, each of which represents the conjoined collection of conditions from a given implementation of the AMBIA process. This theory is used to codify human experience with interoperability assessment into axioms, e.g., if a necessary condition is not met, the design is not interoperable. The theory is validated empirically using, for example, a lightweight formal methods tool known as alloy analyzer. It should be appreciated that other types of method tools may be used, such as ProB, USE, VDMTools, or Jaza.

The theory is based on the premise that one can enumerate certain conditions that are necessary for performer interoperability in a design. Let I stand for the nullary predicate “the design is interoperable.” If the design is interoperable, the first level necessary conditions hold

I→(C₁ [symbol] C₂ [symbol] . . . [symbol] Cₘ) Equation (1)

The AMBIA process takes the approach of exploring the impact of the absence of necessary conditions on interoperability. By contraposition, if one or more of the first-level conditions is not met, the design is not interoperable:

[symbol]

C₁→ [symbol] I,

[symbol]

C₂→ [symbol] I,

. . .

[symbol]

Cₘ→ [symbol] I Equation (2)

or more generally, for any 1<=i<=m,

[symbol]

Cᵢ→ [symbol] I Equation (3)

where i denotes the implementation number of AMBIA.

For each of the first level conditions that are necessary to make a design interoperable, there are one or more second level necessary conditions, as follows.

Cᵢ→(C_{i,1} [symbol] C_{i,2} [symbol] . . . [symbol] C_{i,n}) Equation (4)

Again by contraposition, if one or more of the second-level conditions is not met, the corresponding first-level condition is not met:

[symbol]

C_{i,1}→ [symbol] Cᵢ,

[symbol]

C_{i,2}→ [symbol] Cᵢ,

. . .

[symbol]

C_{i,n}→ [symbol] Cᵢ Equation (5)

or more generally, for any 1<=nᵢ<=n,

[symbol]

C_{i,n}_{ᵢ}→ [symbol] Cᵢ Equation (6)

where nᵢ is a number for a condition formalized during implementation i that may be different for different i.

The conditions may be transitive from bottom to top such that

(( [symbol] C_{i,n}_{ᵢ}→ [symbol] Cᵢ) [symbol] ( [symbol] Cᵢ→ [symbol] I))→( [symbol] C_{i,n}_{ᵢ}→ [symbol] I) Equation (7)

Transitivity is proven in this research by experimentally validating the truth of the above equation for three implementations of the AMBIA process.

It may not be known for certain in advance which conditions are necessary and which conditions are not. A condition that an analyst intuitively thinks is necessary may not be if its logic is subsumed within another condition. Each first and second level condition is tested to see whether it is necessary to make the condition it decomposes true.

The key premise of this approach is that the known necessary conditions are enumerated, and the formal definition of interoperability I is gradually extended as more conditions are found. While the goal of a complete formal model of interoperability conditions maybe idealistic, it is not unattainable to find a finite subset of conditions that are necessary for interoperability of a design, i.e., conditions without which the design cannot be considered interoperable. These conditions are documented formally and abstractly so that designs following an equivalent CDM can be checked for the presence of those conditions to bring to the architect's attention any known interoperability deficiencies in the design.

As implied in the equations, the number of first and second level necessary conditions is extensible as new conditions for interoperability are collected, formalized, tested for necessity, and added to the conjunctive expressions. This list of conditions is intended to grow to represent current knowledge about interoperability deficiencies based on architecture model classes and relationships. As the expressions grow, so does the resolution of the architect's capability to remove known interoperability issues from the design before implementation.

FIG. 3 is a block diagram 300 illustrating a computing system configured to execute an AMBIA process, according to an embodiment of the present invention. Computing system includes a bus 305 or other communication mechanism for communicating information, and processor(s) 310 coupled to bus 305 for processing information. Processor(s) 310 may be any type of general or specific purpose processor, including a central processing unit (CPU) or ASIC. Processor(s) 310 may also have multiple processing cores, and at least some of the cores may be configured to perform specific functions. Computing system further includes a memory 315 for storing information and instructions to be executed by processor(s) 310. Memory 315 can be comprised of any combination of random access memory (RAM), read only memory (ROM), flash memory, cache, static storage such as a magnetic or optical disk, or any other types of non-transitory computer-readable media or combinations thereof. Additionally, computing system 300 includes a communication device 320, such as a transceiver, to wirelessly provide access to a communications network.

Non-transitory computer-readable media may be any available media that can be accessed by processor(s) 310 and may include both volatile and non-volatile media, removable and non-removable media, and communication media. Communication media may include computer-readable instructions, data structures, program modules or other data in a modulated data signal such as a carrier wave or other transport mechanism and includes any information delivery media.

Processor(s) 310 are further coupled via bus 305 to a display 325, such as a Liquid Crystal Display (“LCD”), for displaying information to a user. A keyboard 330 and a cursor control device 335, such as a computer mouse, are further coupled to bus 305 to enable a user to interface with computing system. However, in certain embodiments such as those for mobile computing implementations, a physical keyboard and mouse may not be present, and the user may interact with the device solely through display 325 and/or a touchpad (not shown). Any type and combination of input devices may be used as a matter of design choice.

In one embodiment, memory 315 stores software modules that provide functionality when executed by processor(s) 310. The modules include an operating system 340 for computing system. The modules further include an AMBIA module 345 that is configured to organize candidate conditions into a hierarchy of logical expressions, and to determine whether each child condition is necessary or unnecessary to its parent condition. Computing system 300 may include one or more additional functional modules 350 that include additional functionality.

In this embodiment, AMBIA module 345 may execute a process pertaining to a theory of interoperability assessment and steps pertaining to practical application of the theory to a real architecture model. The process pertaining to the theory utilizes model-finding tools to help the analyst discover reusable patterns that can then be matched separately against data in architecture modeling tools as part of the practical application side of the process.

For example, AMBIA module 345 may identify an AMBIA use case, e.g., describe what specific analysis questions must be answered by the interoperability assessment to bound the problem space. AMBIA module 345 may also identify a data model subset, e.g., identify a subset of classes and relationships from model M having relevance to interoperability. AMBIA module 345 may further add constraints to the model, e.g., build a model of the relevant classes and relationships from model M using relational logic, and add constraints to exclude instances that exhibit a poor general design practice and also exclude instances that may prevent interoperability for a given use case.

It should be appreciated that axioms (or, in some cases, heuristics) are based on how an analyst or a community of stakeholders defines interoperability in unambiguous terms with respect to architecture model elements and relationships. AMBIA module 345 may also formalize a set of axioms for non-interoperability of the design based on human experience and the conditions discovered in the previous step. AMBIA module 345 also identifies necessary conditions, e.g., determines which of the new constraints are necessary for interoperability of the design based on the established axioms, and categorizes and documents these constraints as either necessary or unnecessary conditions. AMBIA module 345 may repeat the process on a larger data model or assess an architecture module. The following subsections describe each step of the process in further detail.

Identify AMBIA Use Case

A use case approach from a user's perspective may be used to describe how an analyst could use the AMBIA process to bind a problem space and conduct an interoperability assessment. Although many additional use cases may exist, the following is provided as an example to demonstrate the concept. The general concept for the AMBIA process is to enable an architect or analyst to investigate at a minimum the following questions: are there any known aspects that may create issues for the interoperability of a design, and/or what specific changes could be made to improve the interoperability of a design?

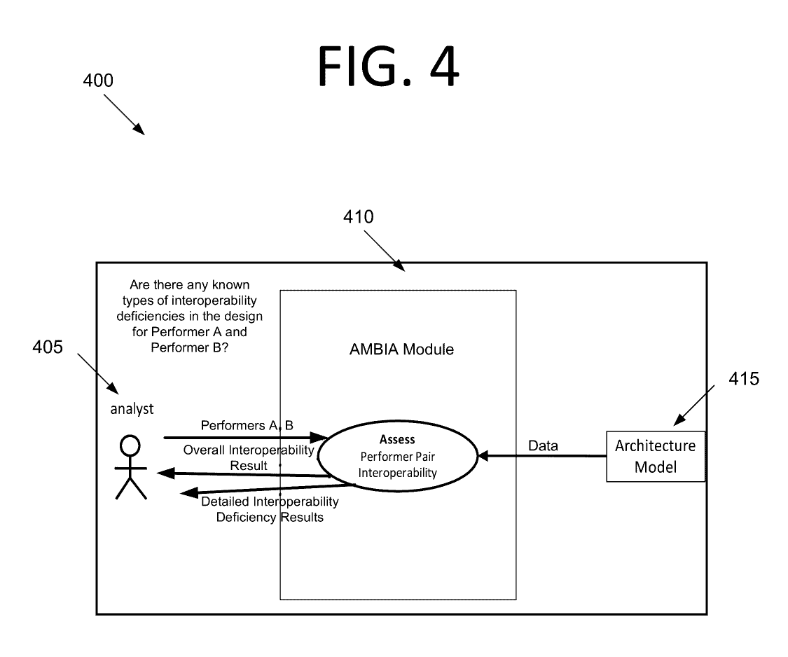

In this example, an analyst working with an architecture model consistent with model M may be motivated to ascertain whether the design described by this architecture model exhibits any patterns of known interoperability deficiencies between two specific performers of interest. See, for example, FIG. 4.

In FIG. 4, an analyst 405 may provide names of the two performers to an AMBIA module 410 to test the performers' design for interoperability. The two performer names (represented by Performer A and Performer B in FIG. 4) are the input data. It should be appreciated that any two performers may be used in the model, whether or not there exists a requirement, documented or implied, for interoperability between them.

Using data from an architecture model 415, AMBIA module 410 assesses interoperability of the design for the performers A and B. AMBIA module 410 then provides the assessment results to analyst 405. Results may include an overall pass/fail assessment for the performer pair (represented by “Overall Interoperability Pass/Fail Result” in FIG. 4), and/or detailed results containing the precise elements and relationships resulting in any failures (represented by “Detailed Interoperability Deficiency Results” in FIG. 4).

The pass or fail result in this example case would answer the first notional question: are there any known aspects that may create issues for the interoperability of the design? If the result is “Pass,” then there are no known aspects of the design that may create issues for interoperability of a design. If the result is “Fail,” then the model under assessment (MuA) contains a pattern previously identified to cause an interoperability deficiency. It should be noted that a “Pass” result does not imply with any certainty that a design is interoperable per the expectations of all stakeholders. Instead, the “Pass” result indicates the absence of any known deficiencies codified in the current AMBIA process. This is a screening test performed on the specification model for known indicators of interoperability deficiencies so that corrective action can be taken early to avoid issues surfacing in the actual system after deployment.

The detailed deficiency results described in this example would also answer the second notional question: What specific changes could be made to improve the interoperability of a design? The result may include a list of elements linked to the performers under test along with the missing relationships that caused them to fail the condition check. This list would enable an architect to pinpoint existing deficiencies in the design so that they can be targeted for correction or accepted as deliberate design decisions.

Identify Data Model Subset

To formulate conditions, variables and predicates must be identified. This is done through examining model M (see FIG. 2) for classes and relationships that may influence interoperability. In each implementation of the AMBIA process, one or more classes are identified, along with a set of relationships. The elements in the classes are the variables in the conditions, and the relationships between pairs of elements are the predicates in the conditions.

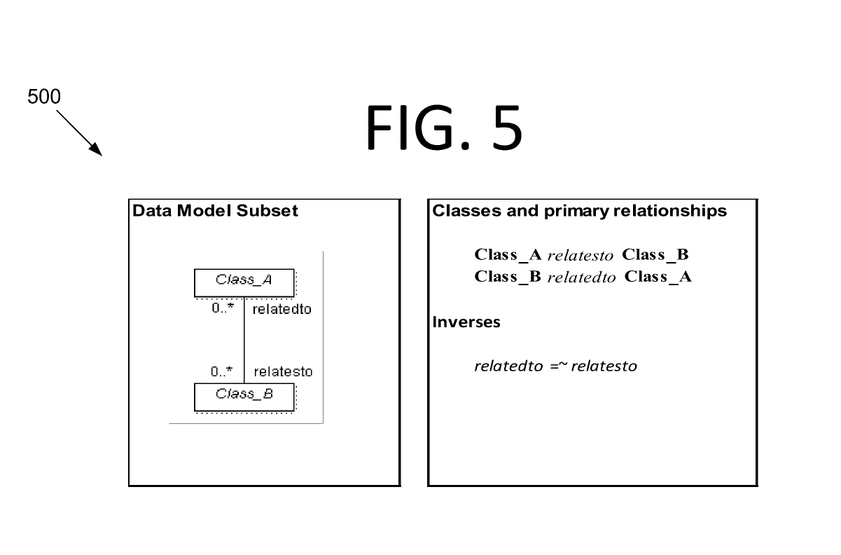

Each implementation documents the results of this step in a graphical depiction of the subset of pertinent classes and relationships, listing the classes and the relation among them and the rationale for their inclusion. FIG. 5 shows a graph 500 illustrating a general format for presenting the results of the first step, using notional classes Class_A and Class_B, and notional relationships relatedto and relatesto for illustrative purposes.

Add Constraints to the Model

The classes and relationships identified in the previous step (i.e., identifying a data model subset step) are codified into a model finding tool. This step of the AMBIA process involves constraining the data model subset to ensure that certain desirable relationships are present or to prevent certain undesirable relationships from occurring. Incorrect or missing relationships between elements in an architecture model can result in design flaws that may impact interoperability.

To implement this step, a tool may be used to generate instances of design that can then be inspected by the analyst for flaws that would impact interoperability. Tools that may be used include ProB, USE, VDMTools, Jaza, and alloy analyzer. USE is based on the object constraint language (OCL), which is the constraint language of the unified modeling language (UML) used in the UPDM specification. For simplicity reasons, embodiments discussed herein utilize the alloy analyzer due to the simplicity of its language and usability compared with the other tools.

This step employs an iterative process of instance inspection and constraint writing until the analyst can no longer find undesirable properties in the data model (or time and/or budget are exhausted). The alloy analyzer is introduced and elaborated on below with respect to how it is used in the AMBIA process.

Alloy analyzer is a tool designed to help humans thresh out design oversights from the earliest behavior models as a relatively low-cost alternative to correcting design flaws later in the lifecycle. With alloy analyzer, it is relatively inexpensive to make design modifications early on in the lifecycle compared to making them post-deployment. Stated differently, the alloy analyzer enables the AMBIA process to predict many design flaws (in this case, interoperability deficiencies) in advance of system deployment.

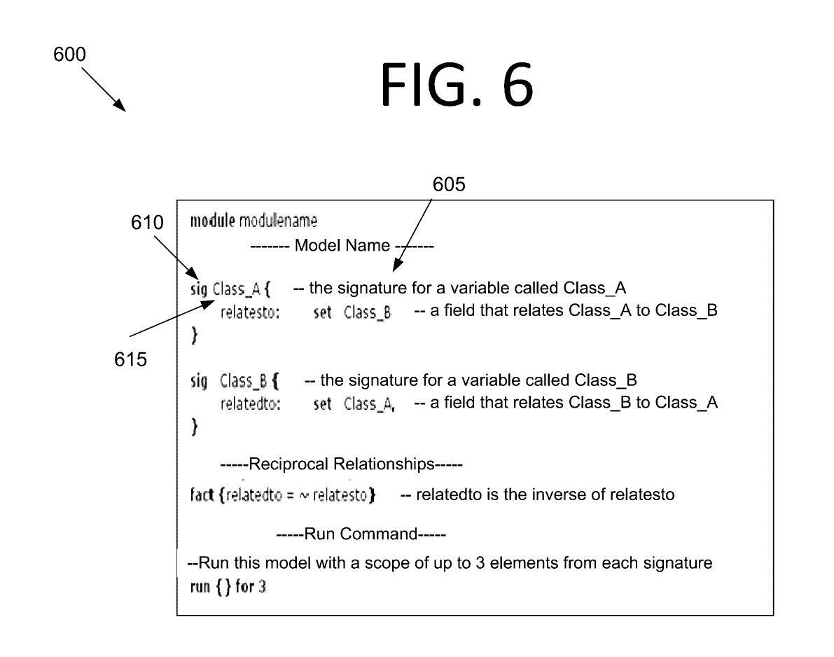

By using the alloy analyzer, the AMBIA process can expand the number of test cases that can be accessed without configuring and testing an actual physical system, and can enable testing as early in the lifecycle as there is data available in an architecture model. For example, a CDM subset may first be translated into the alloy language. The alloy model may be structured in the format shown in FIG. 6. Comments 605 annotate the code to describe the keywords 610 and variables, attributes, and operators 615. The two classes Class_A and Class_B (see, for example, FIG. 5) are defined as signatures with fields each representing a relation. A reciprocal relationship is also defined as a fact so that logical statements can be written from either perspective. A fact is a global constraint that holds true in the model at all times.

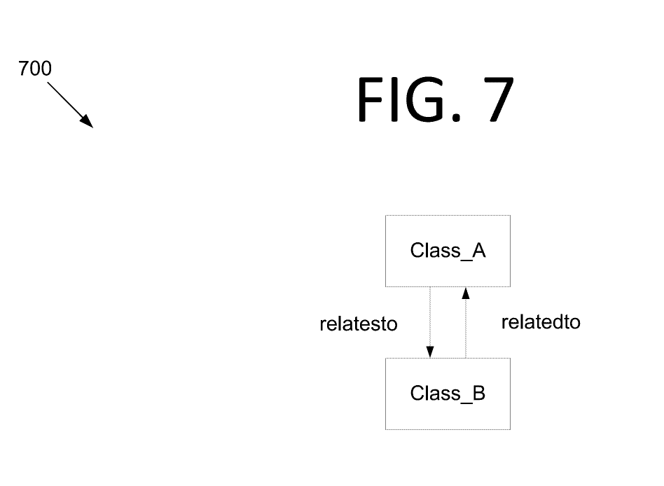

FIG. 7 illustrates a metamodel 700 generated by the alloy analyzer module from the alloy code (or alloy model) shown in FIG. 6, according to an embodiment of the present invention. It should be noted that metamodel 700 has an identical meaning to data model subset 500 of FIG. 5, except that the alloy diagram of metamodel 700 does not show multiplicity. The multiplicity of “0 or more” is captured in the set keyword in the code.

The scope in the run command is set to a maximum of three elements of each class in this embodiment. Stated differently, all of the instances will be limited to containing no more than three of each type of variable declared in the signatures. Increasing the scope results in more variables being allowed to appear in instances, and decreasing the scope results in fewer variables being allowed to appear in instances.

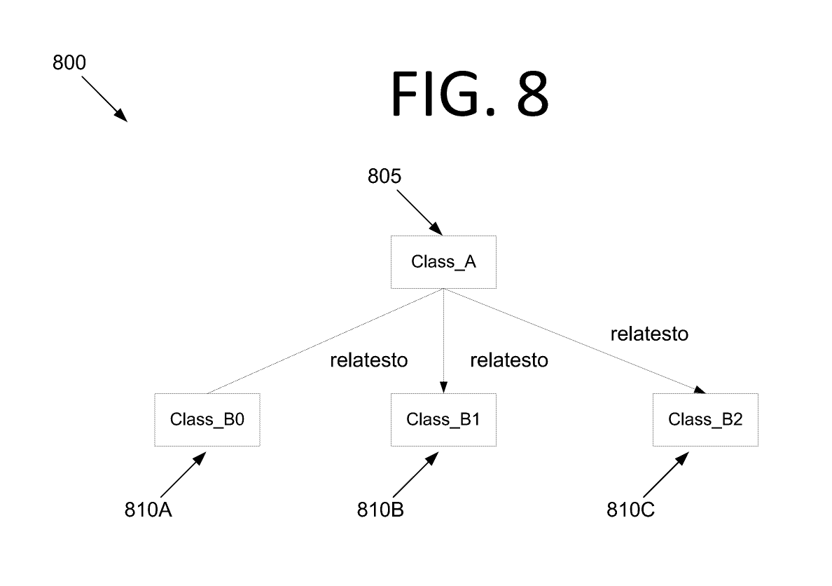

When the run command in the alloy model is executed, a satisfiability (SAT) solver, which is part of the alloy analyzer module, changes the numbers and combinations of the variables and their possible relations until it finds a solution that satisfies all constraints simultaneously. When an instance is found, it is displayed graphically so that the analyst can inspect the instance for any properties that are not intended to be present in the design. For example, when the run command is executed in alloy model 600 of FIG. 6, instance 800 in FIG. 8 is the first result displayed in this embodiment.

In this embodiment, instance 800 has been tailored in settings to only display the relatesto relation. Hiding some of the reciprocal relationships keeps instance 800 clean and easy to read, and is especially useful when viewing an instance with many elements, for example. In this case, an element 805 in Class_A relates to three elements 810A, 810B, 810C in Class_B. The analyst must decide whether this scenario is acceptable for the design. When the alloy analyzer module presents an instance displaying an undesirable property for a design, the analyst can write a constraint to prevent the occurrence of that property. For example, if the analyst wants an element in Class_A to only relate to a maximum of two elements in Class_B, a constraint can be added to the model. For example, the constraint “element of Class_A relates to no more than two elements of Class_B” may be added.

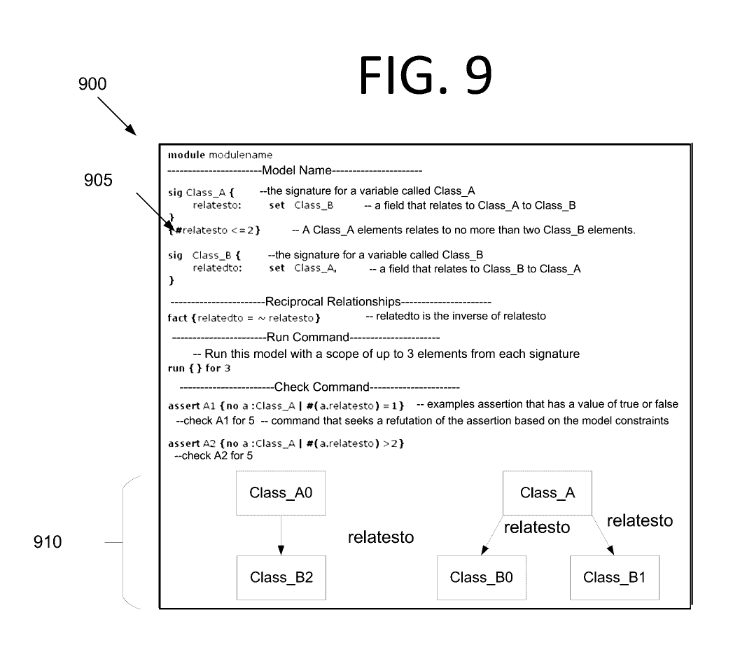

This condition can be codified in the alloy analyzer module as shown by item 905 of FIG. 9, and when the updated model is executed, new first instance 910 appears. New instance 910 shows one element of Class_A relating to one element of Class_B, and shows a different element of Class_A relating to two elements of Class_B. Stated differently, this instance meets the new constraint. This process of instance inspection and constraint writing is repeated until an analyst can no longer find undesirable properties.

Although the main goal of the use case 400 shown in FIG. 4 is to find and prevent instances where two performers (Performers A, B) in the design are not interoperable, other potentially undesirable instances are also found in the design. To help keep the constraints organized according to purpose, the constraints are sorted by the analyst into the categories guideline conditions and interoperability conditions as the constraints are added to the model.

Guideline conditions categorize constraints that capture general modeling best practices and may or may not impact interoperability. Interoperability conditions categorize constraints that were developed with interoperability as a consideration (e.g., as in the performer pair interoperability shown in FIG. 4). Finally, the constraints are summarized in predicate calculus. For example, a condition that requires an element of Class_A to relate to no more than two elements of Class_B may include the following equation:

(∀aεClass_A)( [symbol] ∃ab₁,b₂,b₃εClass_B)relatesto(a,b₁) [symbol] relatesto(a,b₂) [symbol] relatesto(a,b₃) Equation (8)

The conditions may be summarized in predicate calculus since this is a more universal notation than the alloy analyzer modeling language, and, therefore, is more directly accessible. Furthermore, having the conditions in formal notation facilitates future automation of condition checking on real architecture models since a script can be written within the constructs of a tool of choice based on the tool-independent logic of the condition to report out any instances of the architecture model that fail to meet the condition.

It should be appreciated that although this process is assisted by a solving capability of an automated tool or module, the tool does not “know” which instances will be problematic for a design, i.e., defined by the human analyst. The tool performs computations that result in the instances or counterexamples, which the analyst must then inspect. This process is dependent on the ability of the analyst to spot scenarios that are problematic in the instances presented. Known conditions for interoperability or other desired design features are incorporated by formulating axioms based on information gathered from other sources, such as via observations of real systems.

As this step of the AMBIA process is executed, over-constraining of the model should be avoided. This can occur by writing false facts or too many facts at a time. Over-constraining the model in AMBIA may be avoided by identifying one undesirable property in an instance, writing a constraint to prevent the over-constraining of the model, and verifying the effect of that new constraint on the model, one property and one constraint at a time, through iterative instance inspection with the run command.

Adding more than one constraint at a time, as may be done in some embodiments, may save time. However, by adding more than one constraint at a time, problems may develop at a later time, such as pinpointing the source of a contradiction in logic. This is due to introducing more than one independent logical expression at a time.

When an instance contains an undesirable property, a constraint to prevent that particular undesirable property may be written. If several undesirable properties are spotted in one instance, only one undesirable property is focused on in the constraint writing so there is a one-to-one mapping between the undesirable property and the constraint. This one-to-one parsing ensures that no more than one property is addressed by a constraint so that when the constraint is added or removed, only one property is added or removed (respectively), and the added or removed property is independent from other properties. Undesirable properties that do not have written constraints will continue to appear in instances after other constraints for other properties are applied if the constraints are independent from each other. In other words, one constraint is added addressing just one undesirable property at a time in this approach to avoid the emergence of hidden overlaps in logic later.

Facts are global constraints that are a part of the alloy analyzer model and assumed to always be true. Thus, it is important that facts not be false themselves. Each fact further constrains the alloy analyzer model so each fact should also be shown to have some basis or rationale and be validated to ensure that each fact can accomplish the result intended by the analyst. Ensuring that the facts are not false themselves may be performed by deriving the facts directly from observed instances (e.g., using the run command) containing undesirable properties, and from no other source, and documenting a rationale that could be based on the analyst's existing knowledge or experience using the instance as a basis for an argument for why the fact is needed. No facts are created without a specific instance that illustrates a consequence of the fact not holding and a specific reason for why that fact belongs in the model. Following the addition of the fact, an immediate verification and validation (V&V) takes place to check that the undesired behavior is successfully addressed by the constraint, and that the new constraint has no unintended side effects. This V&V is performed through manual inspection of the instances after the constraint is added, and before any other constraints are added. In short, the alloy analyzer model only contains facts that have a supporting discussion and rationale behind their existence and have undergone V&V independent of one another.

Another way to perform validation of the conditions and assertions is by analyzing consistency. If the conditions do not hold simultaneously, there is some contradiction among the conditions. The alloy analyzer reports this situation as “No instance found. Predicate may be inconsistent.” By conducting this validation each time a constraint is added, an analyst would know immediately if a recent change caused a contradiction, and the analyst can trace the source of the contradiction using the most recently added constraint as a starting point. This is why only one constraint at a time is added to the model. The consistency of all conditions is demonstrated when the alloy analyzer module finds at least one instance where all conditions in the alloy analyzer model are satisfied at the same time.

Formalize Axioms

Axioms are used in this step to codify the experience of humans who have dealt with interoperability failures. The codification of best practices and lessons learned from one system into formal notation based on a defined CDM enables the capture of human knowledge in a way that can be translated to other systems that are described by a compatible CDM. This allows for a more direct reuse of the experience and lessens the burden on humans to find, read, and remember the relevant experience of others. The formalization of axioms is the externalization of human experience. Formal axioms are a vehicle for the communication of best practices and lessons learned with minimal error and high reusability. The CDM may provide the language and taxonomy for the axioms, which describe fundamental concepts that derive from interoperability observations of real deployed architectures. The model finding process in this step assists humans by eliciting these experiences, bringing tacit assumptions to light. A collection of axioms for interoperability assessment, in terms of architecture model classes and relationships, provides the foundational logic for testing and implementing the theory of necessary conditions for interoperability of a design.

Axioms may be logically summarized as “if condition X_{j,k} does not hold, then the design is not interoperable.” The rationale for the axiom, which may be predicated on historical data, inspection of instances a model finder tool such as the alloy analyzer, and general experience in interoperability assessment, is then provided. The axiom format maps to the arrangement of variables in Equation (3) explained in the new theory of interoperability ( [symbol] Cᵢ→ [symbol] I). To encode the axioms as an assertion in condition Cᵢ is broken down into a conjunction of axiomatic conditions as follows:

[symbol]

(X_{i,1} [symbol] X_{i,2} [symbol] . . . [symbol] X_{i,j})→ [symbol] I Equation (9)

where i is the implementation number of AMBIA and j is an axiomatic condition number.

Identify Necessary Conditions

The categorized conditions from ADD CONSTRAINTS step are next evaluated using the alloy analyzer module to identify those conditions that are necessary for interoperability of the design. Necessary conditions for interoperability include conditions whose absence results in non-interoperability of a design. Differentiating between necessary and unnecessary conditions supports a general principle in systems design to avoid over constraining a design without need since this places unnecessary limits on the feasible solution space. Including conditions that are not necessary for a given characteristic (such as interoperability) over-constrains the model, and could result in a failure to consider all feasible solutions later in design.

This subsection presents two approaches for determining dependencies among the conditions that inform on each condition's necessity. The first approach is a partial test of one condition at a time using the model constructed in the ADD CONSTRAINTS step, and the second approach conducts a manual pairwise inspection of all conditions, followed by a semi-automated V&V using a slightly restructured version of the same model. Both approaches use assertions to check the model.

Partial Test Approach

The Alloy model generated in the ADD CONSTRAINTS step can be reused to conduct a quick experiment to find dependencies of the axiomatic conditions on each condition discovered during the model finding process. As a basis for evaluation using this approach, the axiomatic conditions are formulated as assertions. Assertions are logic statements that evaluate to either true or false when checked against the model. If an analyst executes the check command on an assertion and the alloy analyzer module finds a solution to the model that makes the assertion false, then the assertion is invalid. If the alloy analyzer module does not find a solution that falsifies the assertion, then the assertion is valid for the scope at which the check command was executed.

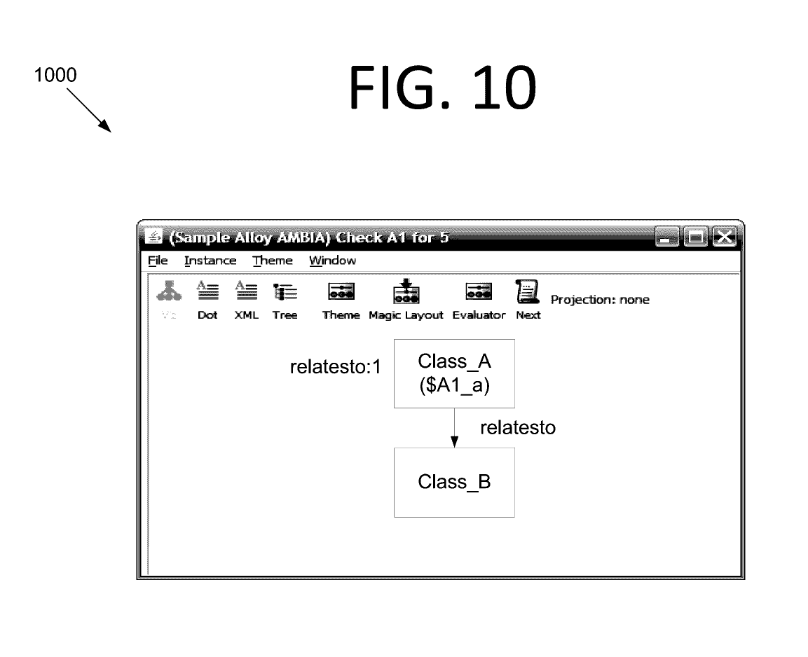

The alloy analyzer module can prove an assertion is false by showing special instances of the model that falsify the assertion called counterexamples. A counterexample can arise when there is a logical contradiction between the model and the assertion such that both cannot be true. For example, if a check command, such as “check A1 for 5” in alloy model 900 of FIG. 9, is executed instead of the run command, a counterexample can be found. See, for example, counterexample 1000 of FIG. 10.

The alloy model is checked at scope 5 to see whether there is no instance containing an element of Class_A that relates to exactly one element of Class_B, as assertion A1 in FIG. 9 shows. Counterexample 1000 conveys that this assertion is false, showing that it is indeed possible for an element of Class_A to have exactly one relatesto relationship with an element of Class_B, based on the facts of the alloy model.

If the “check A2 for 5” command in FIG. 9 is executed instead of the “check A1 for 5” command, no counterexamples are found. The counterexample for assertion A2 states that there is no instance at scope 5 where an element of Class_A relates to more than two elements of Class_B. This is because a fact was added for the previous example condition (i.e., an element of Class_A relates to no more than two elements of Class_B) that bounds the alloy model to prevent any instances that falsify this particular assertion.

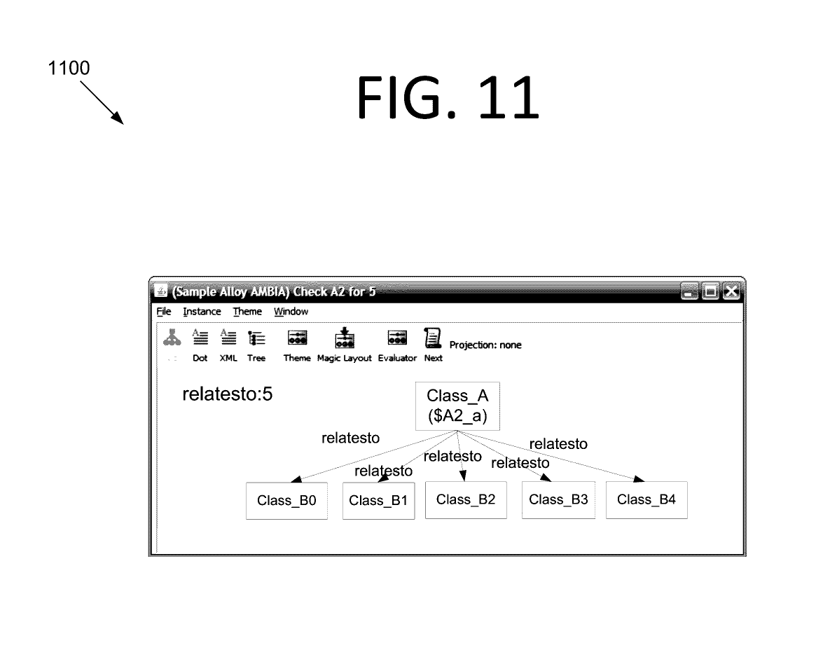

However, if the constraint on the number of Class_A's relations is removed, counterexample 1100 is generated (see FIG. 11). Now, when assertion A2 is checked, there is a counterexample. FIG. 11 shows a counterexample 1100 with an element of Class_A related to five elements of Class_B. Therefore, the assertion A2 has a dependency on the example condition discussed above.

To test one condition and assertion at a time for a dependency, a run matrix similar to Table 1 can be set up for each AMBIA implementation.

TABLE 1
SAMPLE RUN MATRIX FOR ASSERTING
CONDITIONS AGAINST ASSERTIONS
OF AXIOMATIC CONDITIONS

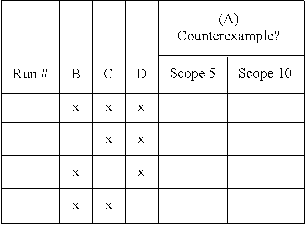

Each run is assigned a unique identifier (e.g., a Run number), and each run removes one condition at a time from the alloy model to determine the impact on the truth value of the asserted axiomatic conditions. On the left side of the table, an “x” in a cell represents the presence of a condition, and a blank gray cell represents the absence of a condition. The presence or absence of a counterexample is recorded on the right as yes or no. In this embodiment, each experiment is run at scope 5 and scope 10 to see whether the removal of any condition resulted in a counterexample at scope 10, but not at scope 5.

The first run of each experiment contains all conditions discovered. If any counterexample appears during this test, then the assertion does not follow from the model facts, and the analyst must trace down the error. It should be appreciated that adding and validating one constraint at a time earlier in the AMBIA process mitigates the risk of finding an inconsistency at this stage. This verification that the assertion follows from all model facts is an important step in establishing a baseline showing that no counterexamples are present when all child conditions are present, and that all conditions can simultaneously hold (i.e., they are consistent). If the assertion check returns no counterexamples, then the analyst is assured of the assertion's validity at the given scope and proceeds with the remaining runs, removing one condition at a time from the model and observing and recording the effects.

To test for dependencies using this approach, the negation of the conditions takes place by removing (i.e., commenting out) one condition at a time from the alloy model and observing the effect on the assertion, which manifests as either counterexample or no counterexample in the alloy analyzer module. To make sure that any counterexamples are a direct consequence of removing a given condition, one, and only one, child condition is removed at a time. The baseline case, which is the first run of the experiment, is that the assertion has no counterexamples.

If, after the removal of a condition, the solver does not find a counterexample, then there is no dependency of the assertion on the removed condition at that scope. If, however, the removal of a condition instigates a counterexample for the same assertion that was previously true, and no other changes to the model were made, then the validity of the assertion is dependent on the removed condition. For example, Equation (10) and Equation (11) show that the removal of condition B results in a falsified assertion A. From these two equations, we conclude that assertion A is dependent on condition B.

A→(B [symbol] C [symbol] D) Equation (10)

( [symbol] B [symbol] C [symbol] D)→ [symbol] A Equation (11)

This approach, although useful for quickly uncovering dependencies between an assertion and conditions, does not immediately distinguish between necessary and sufficient conditions. The limitation in this approach is a consequence of the truth value of all conditions, other than the one removed, being held constant at true in each run. Therefore, one cannot conclude that condition B is a necessary condition for assertion A without further testing (A→B?). Condition B, along with other conditions, may simply be sufficient for assertion A, in which case, the model may be over-constrained. The restrictive constraint may or may not have a consequence on the design. The impact of the consequence should be evaluated before making a decision to constrain a design with a condition that is sufficient for an axiomatic condition to hold, but not necessary.

The dependency relationship is validated by viewing the counterexamples. The figures of the counterexamples demonstrate that the false assertion is due specifically to the removal of a constraint, and is not just a random depiction of the alloy model that results from too broad of an assertion. An assertion that is too broad may be avoided by using only the axiomatic conditions to construct it Like model facts, there is no logic in assertions that is assumed or do not have a rationale. Assertions are formulated directly from the axioms.

To summarize, the partial test entails the assertion of axiomatic conditions on a model constrained by all conditions except the one under test. This approach calls for reuse of the same model and a semi-automated inspection process using a model finding tool, and constitutes a quick means to discover some conditions on which the assertion is dependent. The limitation of this partial approach is that it does not find dependencies between all conditions.

Full Pairwise Test Approach

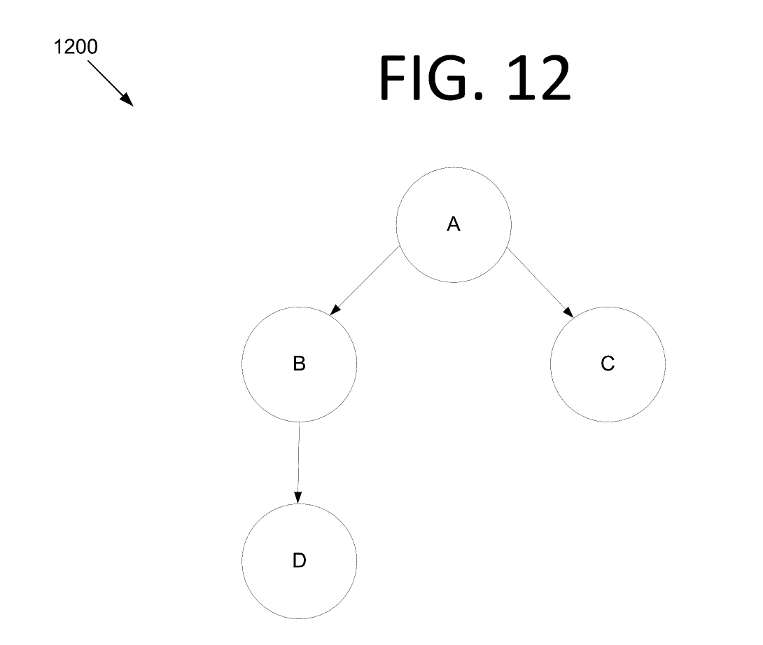

In the full pairwise approach to finding necessary conditions, each interoperability condition is inspected against each other condition to see whether there is an implication dependency between the pair. The results of the inspection are summarized in graph 1200 of FIG. 12, where the nodes represent conditions and the edges represent implications. In this illustration, node D is necessary for node B, and node B and node C are both necessary for node A. By transitivity, node D is also necessary for node A.

A model finding tool, such as the alloy analyzer module, is used to validate the manual inspection. The alloy model-generated ADD CONSTRAINTS step is restructured to conduct a more thorough pairwise experiment to find necessary conditions for interoperability. This restructuring leads to the assertion of each condition to each other condition on a model being unconstrained by any interoperability condition. In the alloy analyzer module, this task is accomplished by using the pred (predicate) keyword in place of fact for stating interoperability conditions, and invoking those predicates only at run time, as opposed to global constraints that are always true.

Table 2 shows an example run matrix for the experiment using this approach. Each condition is paired with each other condition, and an assertion is made that an implication relationship exists. If a counterexample appears, then the assertion is false and no implication dependency exists. If no counterexample is found, then the assertion is true for that scope and an implication dependency is recorded as an x in the appropriate cell. For example, Table 2 shows A→B and, therefore, node B is a necessary condition for node A. The results match those in graph 1200.

TABLE 2
SAMPLE RUN MATRIX FOR
ASSERTING AN IMPLICATION
RELATIONSHIP FOR EACH
PAIR OF CONDITIONS

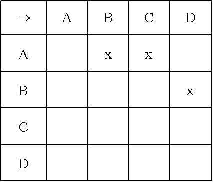

The full test examines each interoperability condition against every other interoperability condition for the presence or absence of an implication relationship. This inspection process can be semi-automated for full pairwise testing by adapting the model finding tool's structure so that the conditions are predicates that are invoked only in an assertion instead of being held as a global fact. The main advantage of this approach is that it considers implication dependencies among all condition pairs. The experiment for the full approach takes a little more time to set up than that of the partial approach, but the alloy analyzer module can execute all runs at once instead of requiring manual commenting out of one fact at a time. A limitation of the current implementation of this approach is that it does not search all dependencies among all combinations of conditions, e.g., (B [symbol] C [symbol] D)→A, or (B [symbol] C)→(A [symbol] D). Such an experiment would involve an exponential increase in the number of runs and need automated support beyond that which was available at the time.

Repeat the Process on a Larger Data Model

Once an implementation of the AMBIA process is complete, the analyst may choose to scale up the assessment by revisiting the original conceptual data model M and exploring more classes and relationships for design properties that potentially impact interoperability. For the purposes of explanation, the analysis will implement the AMBIA process three times (a first implementation plus two iterations) to demonstrate the repeatability of the method and extensibility of the formal model.

AMBIA Implementation M′

This section discusses the first implementation of the AMBIA process, focusing on an initial subset of classes and relationships of model M, called M′. The results of each step of the process are summarized in this section.

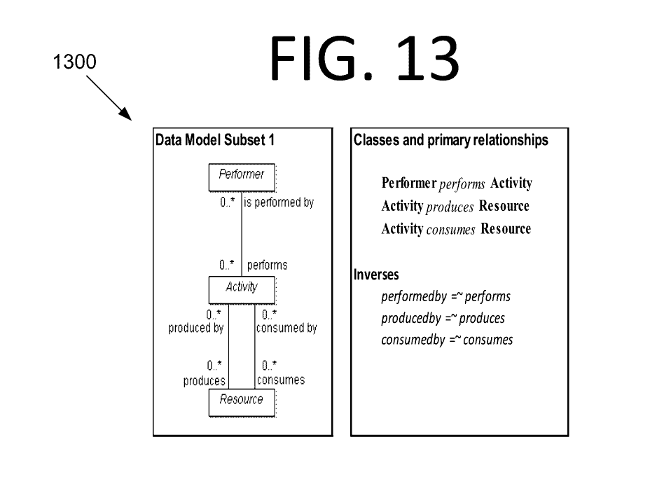

First, an AMBIA use case is identified. See, for example, the perform pair interoperability use case shown in FIG. 4. Next, a data model subset of M′ is identified. See, for example, FIG. 13. Then, constraints are added to model M′.

TABLE 3
ALL CONDITIONS, AMBIA IMPLEMENTATION 1 (M′)

| ID | Description | Rationale |
|---|---|---|
| G_{1,1} | No activity produces | Activities should transform |
| | and consumes the same | inputs into different outputs. |
| | resource. | |
| G_{1,2} | If any activity produces | The design should be consistent |
| | a resource, it also | with the law of conservation |
| | consumes a resource. | of energy. |
| G_{1,3} | All disjoint performers | For designs that allow only one |
| | perform disjoint | performer of each activity |
| | activities. | (at a time). |
| G_{1,4} | Each performer performs | For designs that allow only one |
| | no more than one | activity for each performer at |
| | activity. | a given level of abstraction. |
| C_{1,1} | Each activity produces | An idle activity could lead to |
| | or consumes at least | interoperability deficiencies if |
| | one resource. | it is expected to produce or |
| | | consume resources. |
| C_{1,2} | Each performer performs | An idle performer could lead to |
| | at least one activity. | interoperability deficiencies if |
| | | it is expected to perform. |
| C_{1,3} | Any resource is produced | Unproduced resources are never |
| | by some activity. | generated and thus lead to |
| | | interoperability deficiencies |
| | | for the consuming performer. |
| C_{1,4} | Any resource is consumed | Unconsumed resources are never |
| | by some activity. | received and thus lead to |
| | | interoperability deficiencies for |
| | | the intended consuming performer. |
| C_{1,5} | Each performer produces a | Can be used to scope the assessment |
| | resource to or consumes a | to interoperability of two different |
| | resource from at least one | performers (as opposed to both |
| | other disjoint performer. | performers being the same). |
| C_{1,6} | Any activity is performed | Activities not allocated to a |
| | by some performer. | performer will not be performed. |

Table 3 summarizes and organizes the constraints discovered during the model building process by condition identifier, along with the rationale.

Following the addition of the constraints, the axioms for model M′ are formalized. Based on data model subset 1300 of FIG. 13 and the insight gained from the process of identifying conditions in the ADD CONSTRAINT step, the following are axioms for non-interoperability: First Axiom—“if there exists a performer that produces a resource that is not consumed by any other performer, the design is not interoperable”; and Second Axiom—“if there exists a performer that consumes a resource that is not produced by any other performer, the design is not interoperable.” These axioms may apply to all but the highest level system contexts, where certain inputs and outputs are assumed, and therefore do not have an explicit source or destination performer, respectively, contained within the model scope to analyze.

The first Axiom is concerned with resources that are produced, but not consumed anywhere in the design. Note that in a real architecture, this may not be a problem. For example, not all published resources may be subscribed to at a given point in time. However, if a resource is produced but not consumed anywhere in the design, then this is a design flaw that impacts interoperability according to the part of a definition that reads “and uses those resources to accomplish performed activities.”

An unconsumed resource is not used. The impact of an unconsumed resource on interoperability can range from negligible to critical. For example, if the unconsumed resource is a piece of information that no other performer ever has a need for over the life of the system, the impact is negligible and the interoperability deficiency may never even be noticed. If the unconsumed resource is a piece of information rarely used but critical when needed, then the interoperability impact is high and will be noticed when the need emerges.

The Second Axiom is fundamental to interoperability because an unproduced resource impacts any exchanges depending on the receipt of that resource in a design. An unproduced resource may cause a blocking event that will interrupt the simulation. Every resource must be produced by an activity, preventing the expectation of something from nothing, consistent with the law of conservation of energy.

The corresponding axiomatic conditions for the First Axiom and the Second Axiom are (respectively):

X_{1,1}. For any performer that produces any resource, there exists some performer that consumes that resource.

X_{1,2}. For any performer that consumes any resource, there exists some performer that produces that resource. It should be appreciated that exception cases may be added for performers that include top-level inputs and outputs whose source and destination performer is deliberately beyond the scope of the model under assessment (MuA).

Once the axioms are formalized, necessary conditions within model M′ are identified. Tailoring Equation (3) for the first implementation of the AMBIA method,

[symbol]

C₁→ [symbol] I Equation (12)

C₁ is the first level necessary condition for M′, and expands into the conjunction of the axiomatic conditions identified on the first implementation:

[symbol]

(X_{1,1} [symbol] X_{1,2})→ [symbol] I Equation (13)

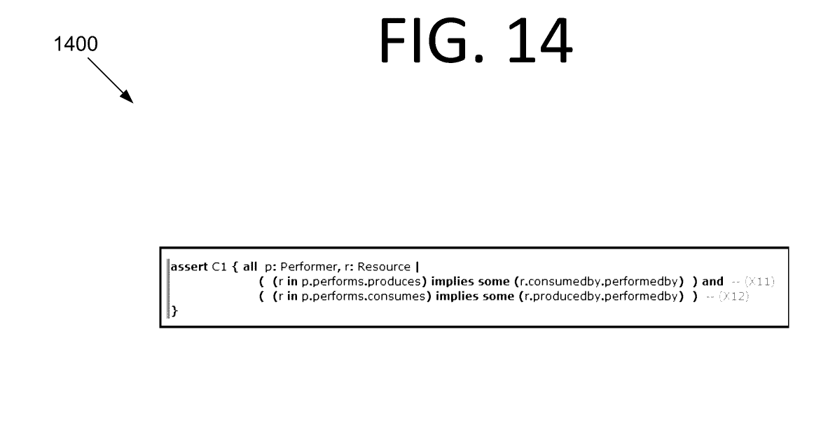

As discussed earlier, a partial and full pairwise test of model M′ conditions are carried out. For the partial test of model M′ conditions, an assertion is written in alloy analyzer module including the conjoined axiomatic conditions of the left side of Equation (13). If either axiomatic condition is falsifiable, a counterexample will be produced, indicating that the design is not interoperable per the stated axioms. FIG. 14 illustrates an assertion of axiomatic conditions for interoperability of design model M′. Stated differently, FIG. 14 shows a formulation of C₁ as an assertion in the alloy model.

Table 4 shows each experimental run and a summary of results for each condition check in alloy analyzer module at scopes 5 and 10.

TABLE 4
M′ EXPERIMENTAL RUNS ASSERTING C₁

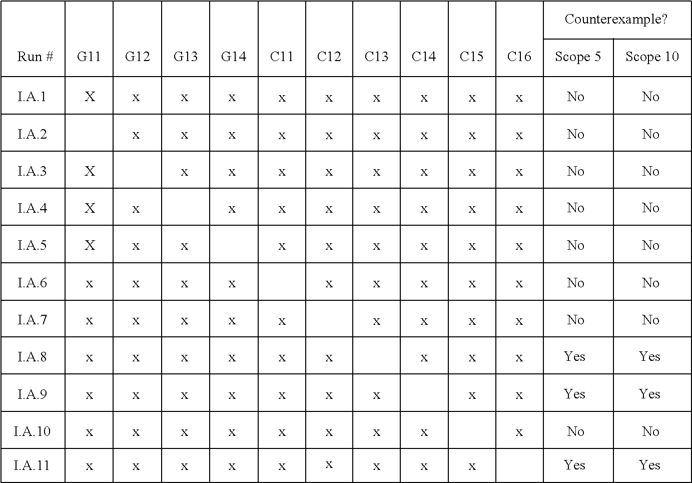

On run I.A.1, C₁ was asserted at scopes 3, 5, 10, 15 and 20, and no counterexamples were returned at any of these scopes. These results demonstrate that the baseline model for model M′ is consistent with the assertion with all conditions present through scope 20.

The results in Table 4 show that assertion C₁ holds at both scope 5 and scope 10 for every run except runs I.A.8, I.A.9, and I.A.11. These runs show that when constraints C_{1,3}, C_{1,4}, or C_{1,6} are removed, a counterexample is found at both scopes. Therefore, with the given set of constraints, C₁ is dependent on C_{1,3}, C_{1,4}, and C_{1,6} for interoperability of the design for M′. Let C_{1,7}=(C_{1,3} [symbol] C_{1,4} [symbol] C_{1,6}). Then,

C_{1,7}→C₁ Equation (14)

Likewise,

[symbol]

C₁→ [symbol] C_{1,7} Equation (15)

C₁ is therefore a necessary condition for C_{1,7} in model M′.

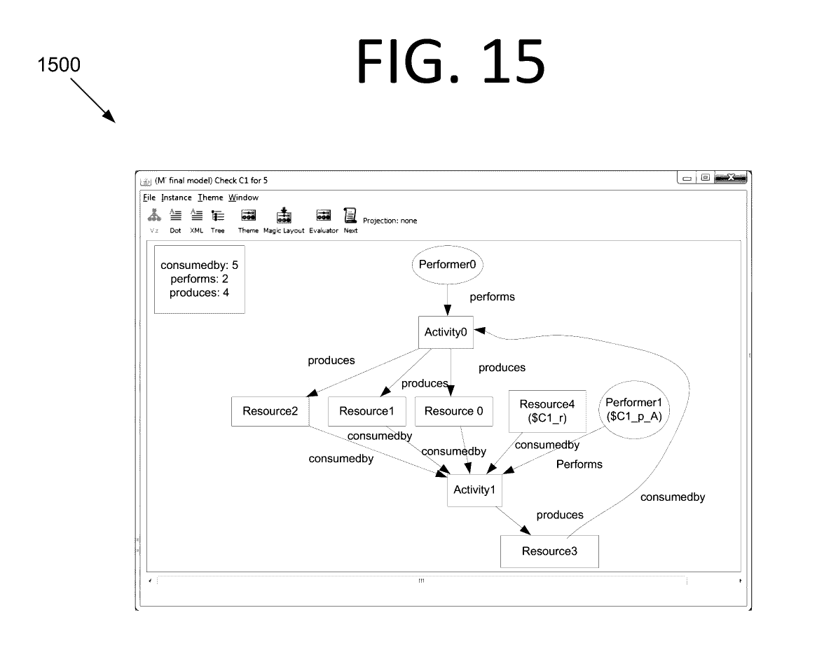

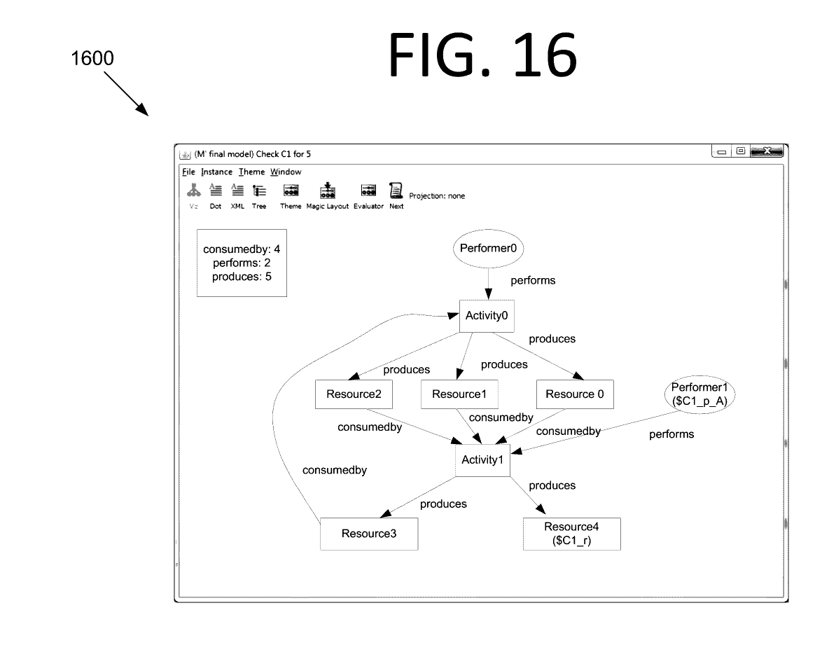

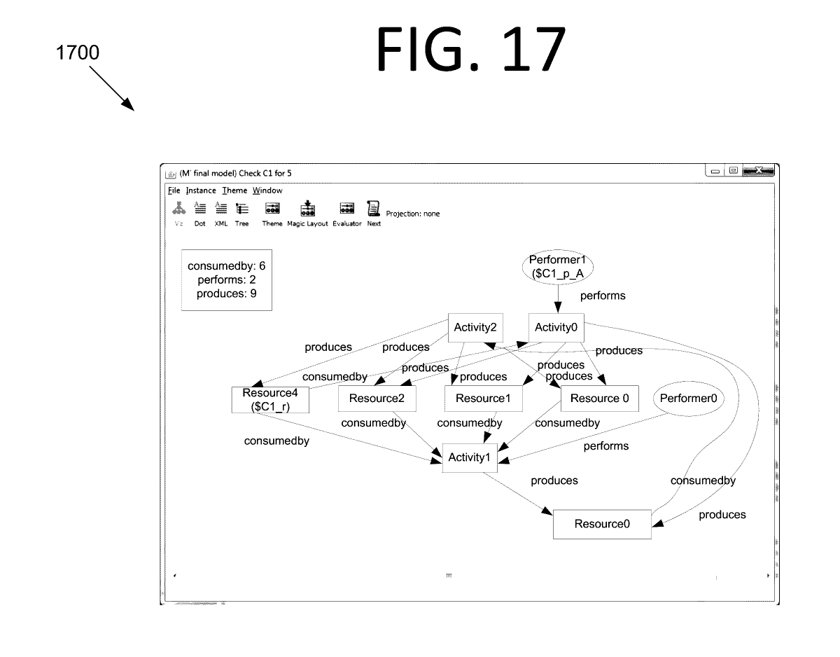

FIGS. 15 to 17 show sample counterexamples for each of the runs with removed conditions, demonstrating possible instances that are counter to the assertion when each condition is absent from the model.

Now that the partial test of model M′ has been discussed, the following is a discussion for the full pairwise test of model M′ conditions.

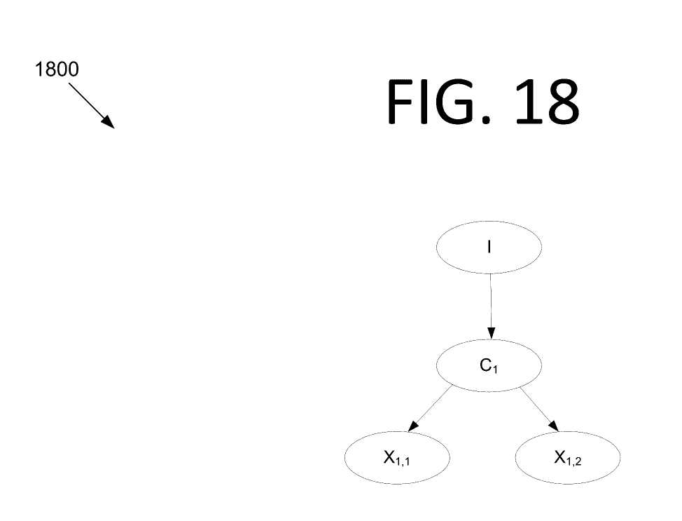

Each interoperability condition in Table 3 is manually inspected against each other condition to see whether there is an implication dependency between the pair. The results of the inspection are summarized for model M′ in FIG. 18. In this embodiment, the only relevant implication dependencies discovered for model M′ are that C₁ is necessary for I (from Equation (12)), and X_{1,1} and X_{1,2} are both necessary for C₁. No other implication dependencies were found on a manual inspection of all the other conditions. This result also serves as a validation that the conditions are constructed to be as independent as possible. For this AMBIA implementation, the axiomatic conditions are fundamental.

AMBIA Implementation: Model M″

Since model M′ contains a limited number of classes and relationships, it is too small to be considered sufficient for capturing all the rules for performer pair interoperability. Even if the analyst presumes that all rules and axioms have been described, there is no way to conclusively prove there are not more that have yet to be discovered and/or formalized. Thus, the AMBIA process is extensible and repeatable to enable this kind of analysis on larger scale data models so that the formal description of interoperability rules can grow as they are discovered. To demonstrate the extensibility of the AMBIA model and repeatability of the AMBIA process, the following description contains an iteration of the process on a slightly extended schema.

In order to formulate additional conditions, more variables and predicates are first identified by examining model M shown in FIG. 2 for additional classes and relationships that influence interoperability of the design. This section expands the subset of classes and relationships of M in a model called M″. Each step of this iteration is summarized below.

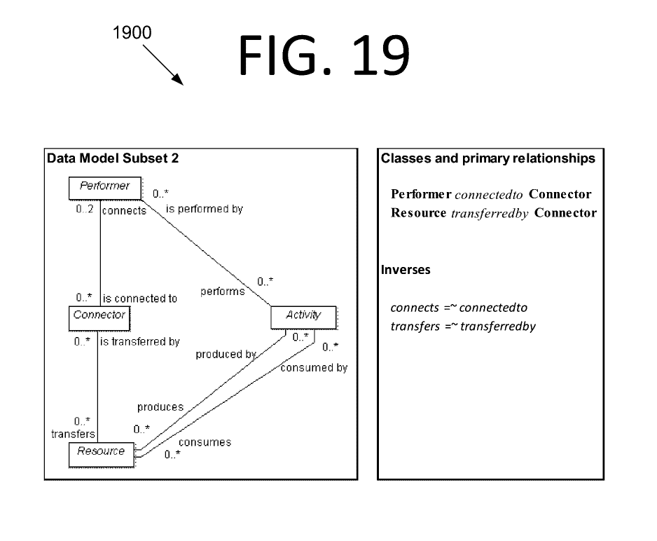

First, an AMBIA use case is identified, i.e., a performer pair interoperability use case is identified, as shown in FIG. 4. Next, a data model subset 2 is identified. See, for example, FIG. 19, illustrating data model subset 2 1900. Constraints to the model M″ are added.

TABLE 5
ALL CONDITIONS, AMBIA IMPLEMENTATION 2 (M″)

| ID | Description | Rationale |
|---|---|---|
| G_{2,1} | Any connector connects | Performers are matched into |
| | no more than two | producer/consumer pairs. |
| | performers. | |
| C_{2,1} | Each performer is | Performers must be attached |
| | connected to at least | to some logical or physical means |
| | one connector. | to exchange any resources. |
| C_{2,2} | If any two performers | Performers that need to exchange |
| | exchange some resource, | a resource must share a common |
| | those performers are | logical or physical connection, |
| | connected to at least | otherwise they have no way to ex- |
| | one common connector. | change resources with one another. |
| C_{2,3} | Every exchanged resource | Exchanged resources must be |
| | between any two per- | associated with some logical or |
| | formers is transferred | physical connection, otherwise they |
| | by some connector. | will not be transferred anywhere. |
| C_{2,4} | Every exchanged resource | Exchanged resources must be |
| | between any two per- | supported by at least one shared |
| | formers is transferred | logical or physical connection be- |
| | by some connector | tween the producing and consuming |
| | that connects those | performers. |
| | performers. | |
| C_{2,5} | Any connector connects | A “dangling” connector that |
| | at least two disjoint | connects only one performer is an |
| | performers. | incomplete specification in adesign |
| | | with multiple performers. |

Table 5 summarizes and organizes the constraints discovered during the model building process in the second implementation of AMBIA by condition identifier, along with the rationale.

Next, axioms for model M″ are formalized. For instance, based on the data model subset 2 1900 of FIG. 19 and the insight gained from the process of identifying conditions in the ADD CONSTRAINTS step, the following is an axiom for non-interoperability: Third Axiom—“if a resource that is exchanged between any two performers is not transferred by some connector that connects those two performers, then the design is not interoperable.”

The rationale for the Third Axiom is as follows. The expression of a requirement for an information exchange, as is performed with classes and relationships in M′, is not sufficient for actually effecting that exchange. Resources must pass through a conduit of some kind from one performer to the other. For example, sound moving through air or water, light moving through fiber optic cable, and electric current moving through copper are all resources moving through connectors. One could also use connectors in a more abstract, solution-neutral sense early in design to specify that a conduit of a yet to be determined design is to exist between two performers. The connector is the logical or physical means by which the performers exchange resources with one another. Specifying connectors early in design at the abstract logical level enables one to see which performers have a need to be connected without the need to fully define the design of that connection at the physical level. Logical connectors can be specified for endpoints that may not be directly physically connected. For example, a logical connector can be specified early in system design between two human performers that need to interoperate, and physical connectors can be specified later during detailed design for the series of technological device performers that make up the physical path of the exchange between the two human performers.

This axiom is also intended to highlight any instances of the design showing performers exchanging resources through performed activities without all of those resources flowing over some supporting connector between the two performers. Not only must any exchanged resources flow over some connector, but the connector must be shared by the producing and consuming performers. If a resource is required to pass from one performer to the other, but is not supported by a connector between these performers, the resource exchange will fail. Therefore, this axiom is needed to prevent designs that allow such unassociated resources.

The corresponding axiomatic condition for the Third Axiom is:

X_{2,1}. Every exchanged resource between any two performers is transferred by some connector that connects those performers.

Once the axioms are formalized, necessary conditions within model M″ are identified. Modifying Equation (3) for the second implementation of the AMBIA method,

[symbol]

C₂→ [symbol] I Equation (16)

C₂ is the first level necessary condition for M″, and is equivalent to the only axiomatic condition identified on the second implementation:

[symbol]

X_{2,1}→ [symbol] I Equation (17)

To identify the necessary conditions, the partial test of necessary conditions of model M′ will first be discussed followed by the full pairwise test.

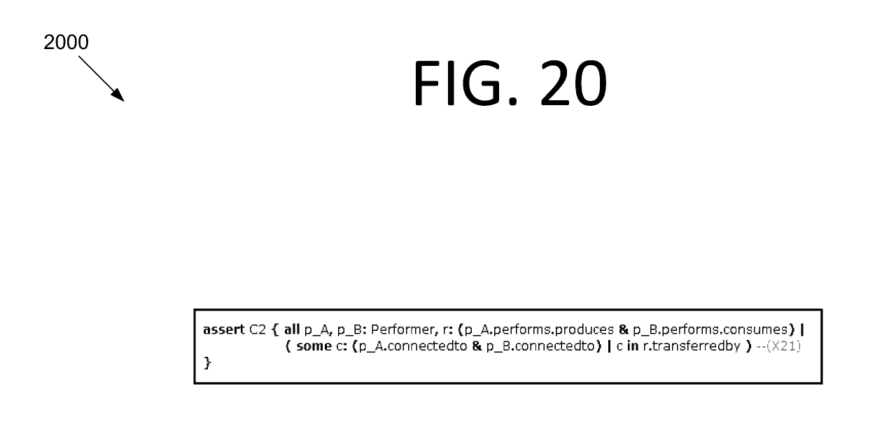

For the partial test, an assertion is written in the alloy model including the axiomatic condition. If the axiomatic condition is falsifiable, a counterexample will be produced, indicating the design is not interoperable per the stated axiom. See, for example, FIG. 20, which shows a formulation of C₂ as an assertion in alloy model 2000, according to an embodiment of the present invention.

TABLE 6
M″ EXPERIMENTAL RUNS ASSERTING C₂

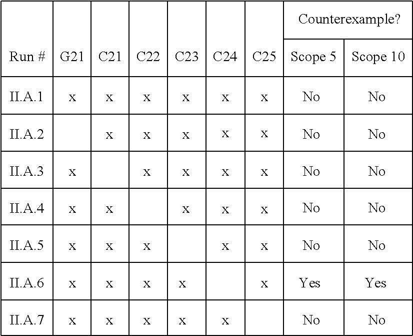

Table 6 shows each experimental run and a summary of results for each condition check in the alloy analyzer at scopes 5 and 10. On run II.A.1, C₂ was asserted at scopes 3, 5, 10, 15, and 20, and no counterexamples returned at any of these scopes. These results demonstrate that M″, with all conditions present, is consistent with the assertion through scope 20.

The results in this table show that C₂ holds at both scope 5 and scope 10 for every run except run II.A.6. Run II.A.6 shows that when constraint C_{2,4} is removed, a counterexample is found at both scopes. Substituting the results of this analysis into Equation (6),

[symbol]

C_{2,4}→ [symbol] C₂ Equation (18)

C_{2,4} is therefore a necessary condition for C₂ in M″.

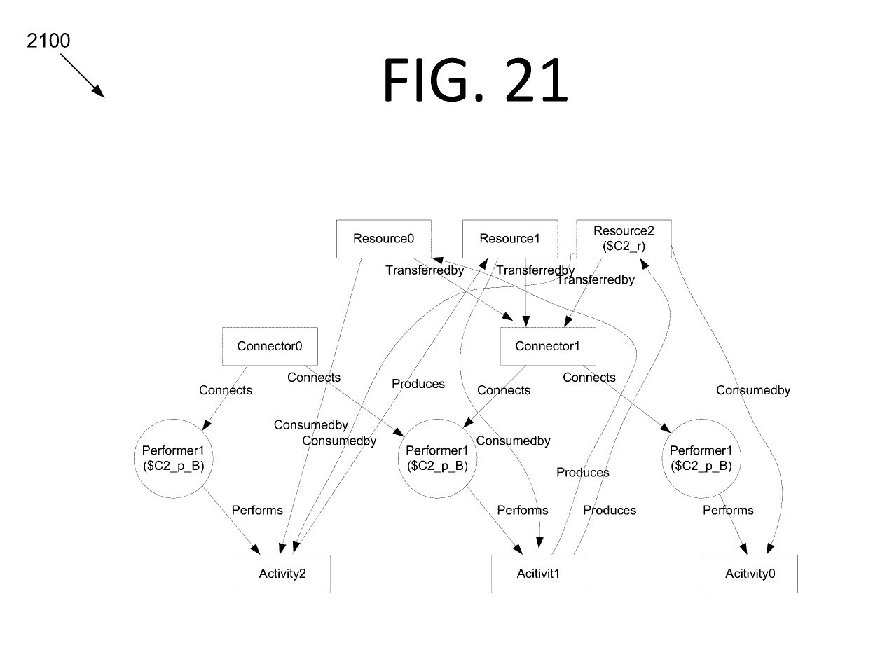

FIG. 21 is a graph 2100 illustrating a counterexample for necessary condition C_{2,4}, according to an embodiment of the present invention. The counterexample for the necessary condition C_{2,4} demonstrates a possible design instance that is counter to the assertion when that condition is absent from the model. In this graph, Resource2 is shown to be transferred by Connector1 that does not connect its producing and consuming performers, i.e., Performer1 and Performer2.

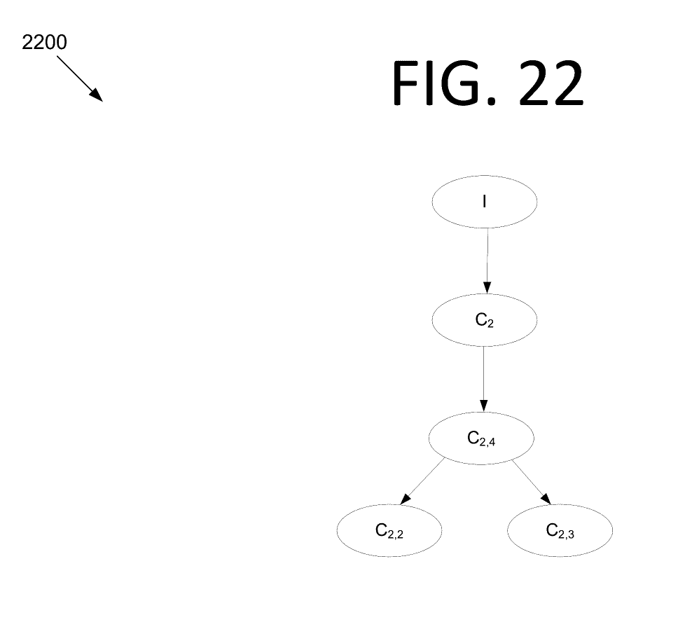

Under the full pairwise test, each interoperability condition in Table 5 is manually inspected against each other condition to see whether there is an implication dependency between the pair. The results of the inspection are summarized for model M″ in graph 2200 of FIG. 22. Graph 2200 shows that C₂ is necessary for I (from Equation (16)), C_{2,4} is necessary for C₂, and both C_{2,2} and C_{2,3} are necessary for C_{2,4}. No other implication dependencies were found on a manual inspection of all the other conditions. These results show how some of the conditions are dependent on other conditions, and follows from some conditions being more restrictive versions of other conditions.

AMBIA Implementation: Model M′″

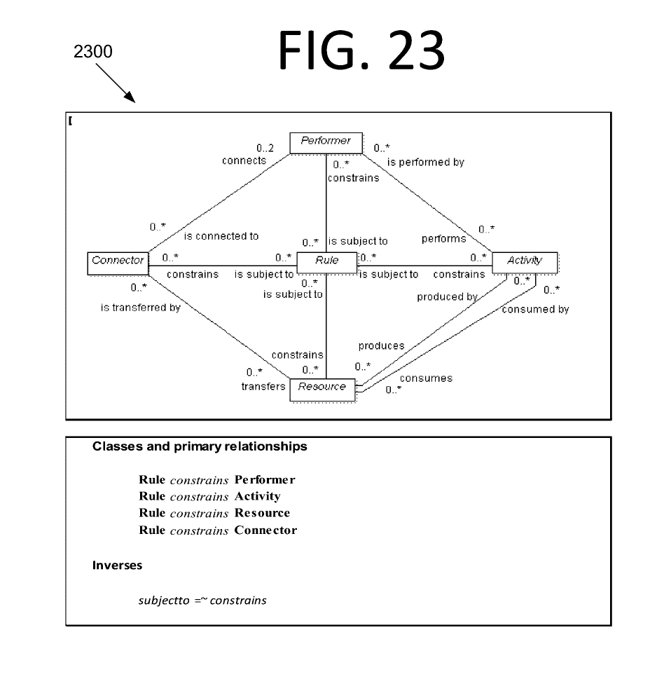

In this embodiment, the subset of classes and relationships in model M are further extended in a model called M′″. For example, a AMBIA use case is identified, as shown in FIG. 2. Next, a data model subset 3 2300, as shown in FIG. 23, for model M′″ is identified. Constraints are then added to model M′″. See, for example, Table 7 below.

TABLE 7
ALL CONDITIONS, AMBIA IMPLEMENTATION 3 (M″′)

| ID | Description | Rationale |
|---|---|---|
| G_{3,1} | Each performer is | A performer with no rules |
| | subject to some rule. | constraining it behaves less |
| | | predictably. |
| G_{3,2} | Each activity is | An activity with no rules |
| | subject to some rule. | constraining it behaves less |
| | | predictably. |
| G_{3,3} | Each resource is | A resource with no rules |
| | subject to some rule. | constraining it may not |
| | | be processed correctly at |
| | | the producer or consumer. |
| G_{3,4} | Each connector is | A connector with no rules |
| | subject to some rule. | constraining it may not have |
| | | the necessary properites to |
| | | transfer a resource. |
| C_{3,1} | If any two performers | Without a common rule |
| | exchange some | governing performer pairs |
| | resource, those per- | exchanging resources, those |
| | formers are subject | performers may follow differ- |
| | to some common rule. | ent rules, or no rules as all. |
| C_{3,2} | Every exchanged | If performers need to ex- |
| | resource between any | change a resource, and |
| | two performers is trans- | that resource is not trans- |
| | ferred by some connector | ferred by at least one |
| | that both connects those | connector subject to some |
| | performers and is subject | rule that also constrains |
| | to some rule that con- | both performers, there may |
| | strains those performers. | not be a workable physical |
| | | or logical path. |
| C_{3,3} | Every connector that | If there are any connectors |
| | connects any two per- | that transfer a resource |
| | formers and transfers | between two performers |
| | an exchanged resource | that are not subject to some |
| | between those per- | rule that also constrains |
| | formers is subject to | both performers, those |
| | some rule that con- | performers may have an |
| | strains those performers. | interoperability deficiency. |
| C_{3,4} | If some resource produced | Performers that exchange a |
| | by any activity a_{A} of any | resource through activities |
| | performer p_{A} is consumed | that are not subject to some |
| | by any activity a_{B} of any | common rule that also con- |
| | other performer p_{B}, then | strains both performers are |
| | a_{A} and a_{B} are subject to | allowed to behave in an |
| | at least one common rule | inconsistent manner. |
| | that constrains both p_{A} | |
| | and p_{B}. | |
| C_{3,5} | Every exchanged resource | If performers need to exchange |
| | between any two performers | a resource that is not subject to |
| | is subject to some rule that | some rule that also constrains |
| | constrains those performers. | both performers, the resource |
| | | may deviate from the one or both |
| | | of the performers' expectations. |

Table 7 summarizes and organizes the constraints discovered during the model building process in the third implementation of AMBIA by condition identifier, along with the rationale.

Based on data model subset 3 2300 of FIG. 23 and the insight gained from the process of identifying conditions in the IDENTIFYING CONSTRAINTS step, the following are axioms for non-interoperability are formalized:

Fourth Axiom. If a resource that is exchanged between any two performers is not transferred by some connector that both connects those two performers and is subject to some rule that constrains those two performers, then the design is not interoperable.

Fifth Axiom. If some activity a_{A} of some performer p_{A} produces some resource consumed by some activity a_{B} of some performer p_{B}, and a_{A} and a_{B} are not subject to at least one common rule that also constrains both p_{A} and p_{B}, then the design is not interoperable.

Sixth Axiom. If a resource that is exchanged between any two performers is not subject to some rule that also constrains those two performers, then the design is not interoperable.

Under the Fourth Axiom, the connector (or the logical or physical connection established between two performers) may conform to rules that govern its form, capacity, and other parameters. The Fourth Axiom implies that each exchanged resource must be transferred by a connector that follows a rule that is also be followed by the exchanging performers. This axiom is based on past experience with performers and connectors with different physical specifications, such as a mouse with a serial connector unable to connect to a computer with no serial ports. In this case, interoperability between the mouse's wire (connector) and the computer (performer) is needed for interoperability between the mouse (the other performer) and the computer.

Under the Fifth Axiom, two performers that need to interoperate may agree to perform their activities according to the same rules. This axiom is based on past experience with performers and performer activities using different standards and protocols to communicate with one another, such as a pair of software applications able to exchange bits of data over a physical connection, but unable to communicate logically because they are speaking different languages. If one of the performers deviates from following the activity's rule, or the activities of each performer do not behave according to the same rule, the design is not considered interoperable. For example, ballroom dancing is an activity that has rules governing its steps that are known by its performers. The rules govern how the steps are combined and executed. The dance performers exchange energy and auditory/visual signals (resources) to communicate throughout the dance. If the leading performer is sending energy and signals for swing, but the follower is expecting energy and signals for the fox trot, the performers will not be able to dance until they agree on a dance with the same rules.

Under the Sixth Axiom, resources can conform to rules that govern their format, content, size, and other parameters. The Sixth Axiom implies that at least one of the resource's rules must also be followed by both performers exchanging the resource. This axiom is based on past experience with performers and resources with different specifications, such as a router trying to send a packet conforming to Internet Protocol version 6 (IPv6) to a router capable of only understanding packets conforming to Internet Protocol version 4 (IPv4). The router running IPv4 will not understand the packet that used IPv6 as the rule, and the routers will fail to interoperate.

The corresponding axiomatic conditions for the Fourth, Fifth, and Sixth Axioms are (respectively):

X_{3,1}. Every exchanged resource between any two performers is transferred by some connector that both connects those performers and is subject to some rule that constrains those performers.

X_{3,2}. If any resource produced by any activity a_{A} of any performer p_{A} is consumed by any activity a_{B} of any performer p_{B}, then a_{A} and a_{B} are subject to at least one common rule that constrains both p_{A} and p_{B}.

X_{3,3}. Every exchanged resource between any two performers is subject to some rule that constrains those performers.

Once the axioms are formalized, necessary conditions within model M′″ are identified. For example, Equation (3) may be modified for the third implementation of the AMBIA process,

[symbol]

C₃→ [symbol] I Equation (19)

C₃ is the first level necessary condition for M′″, and expands into the conjunction of the axiomatic conditions identified on the third implementation:

[symbol]

(X_{3,1} [symbol] X_{3,2} [symbol] X_{3,3})→ [symbol] I Equation (20)

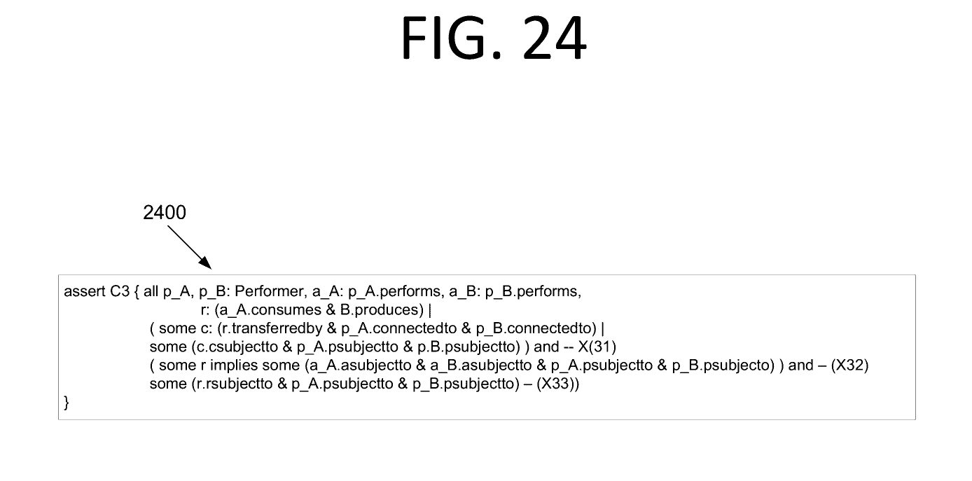

Under the partial test for model M′″, an assertion is written in alloy model 2400 including the conjoined axiomatic conditions. If any axiomatic condition is falsifiable, a counterexample will be produced, indicating the design is not interoperable per the stated axioms. FIG. 24 shows the formulation of C₃ as an assertion in alloy model 2400.

TABLE 8
M′′′ EXPERIMENTAL RUNS ASSERTING C₃

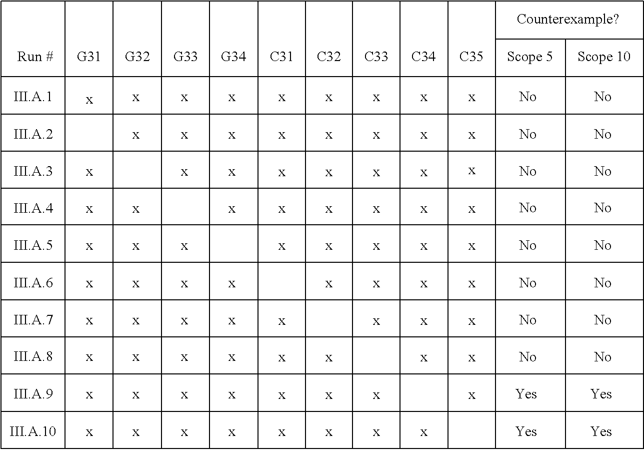

Table 8 shows each experimental run and a summary of results for each condition check in alloy analyzer module at scopes 5 and 10. On run III.A.1, C₃ was asserted at scopes 3, 5, 10, 15 and 20, and no counterexamples were returned at any of these scopes. These results demonstrate that the baseline model for M′″ is consistent with the assertion with all conditions present through scope 20. The results in this table show that assertion C₃ holds at both scope 5 and scope 10 for every run except runs III.A.9 and III.A.10. These runs show that when constraints C_{3,4} or C_{3,5} are removed, a counterexample is found at both scopes. Substituting the results of this analysis into Equation (6),

[symbol]

C_{3,4}→ [symbol] C₃ Equation (21)

[symbol]

C_{3,5}→ [symbol] C₃ Equation (22)

C_{3,4} and C_{3,5} are therefore necessary conditions for C₃ in M′″.

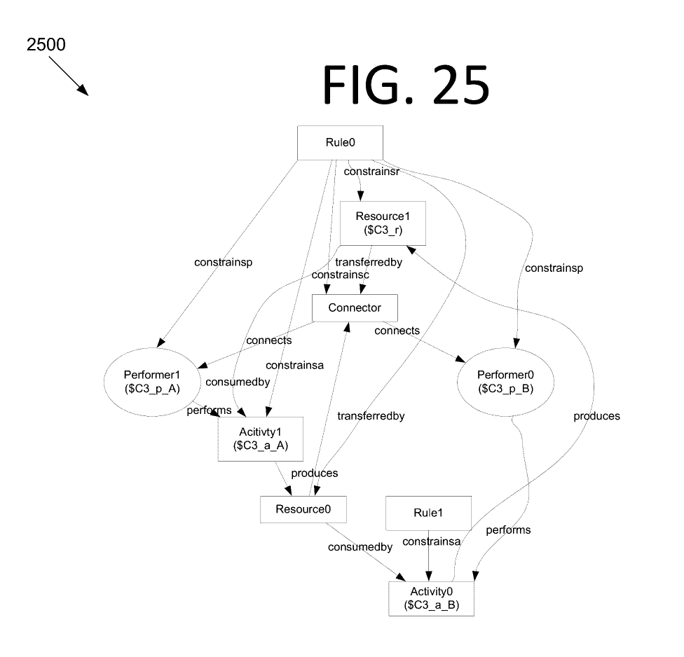

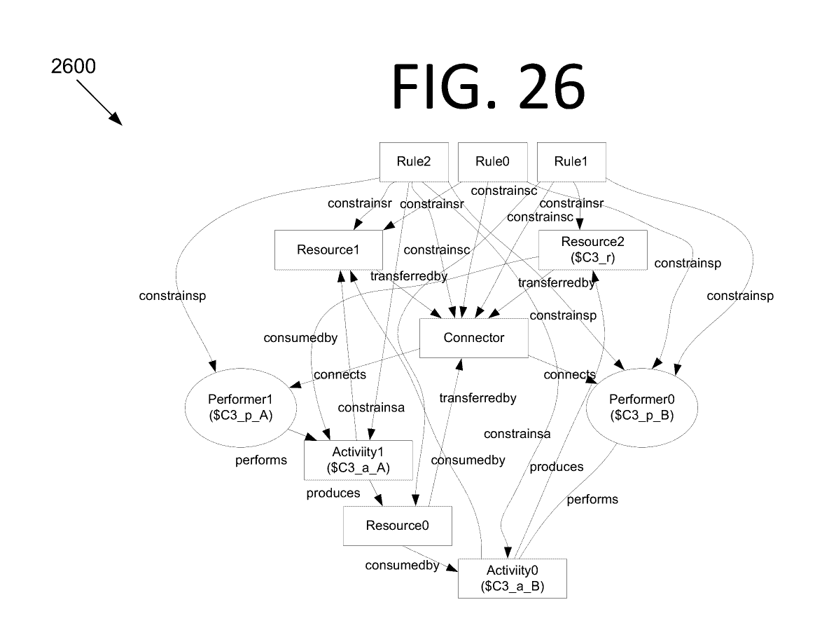

FIGS. 25 and 26 show sample counterexamples 2500, 2600 for each of the necessary conditions, demonstrating possible instances that are counter to the assertion when each condition is absent from the model. Interestingly, C_{3,2} was also suspected to be necessary, but proved in the test results to be unnecessary in the presence of all the other conditions. To investigate the cause of this result, C_{3,2} is removed from the model and all the runs are repeated in Table 9.

TABLE 9
M′′′ EXPERIMENTAL RUNS ASSERTING C₃, REPEATED WITHOUT C_{3,2}

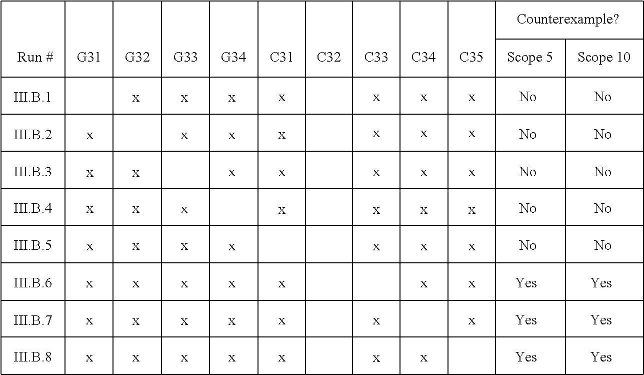

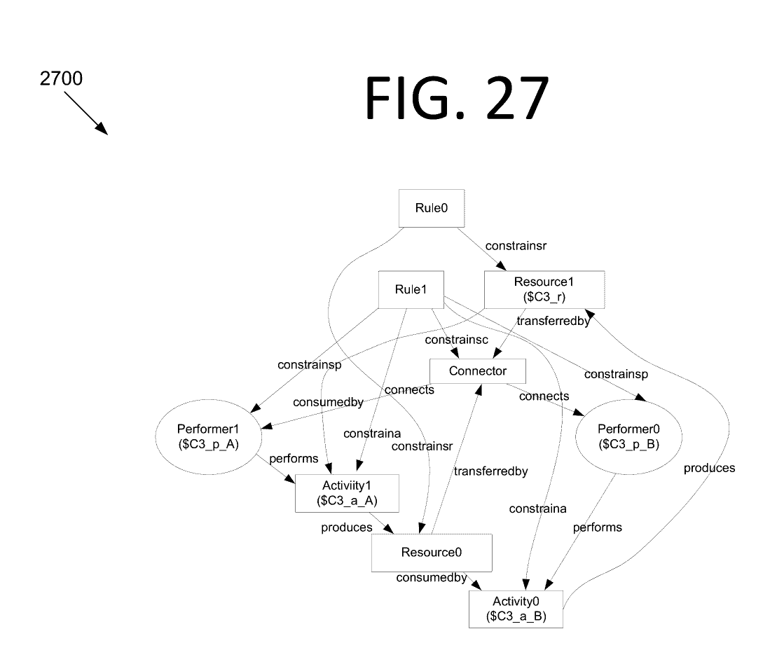

Run III.B.6 reveals that C_{3,3} becomes necessary in the absence of C_{3,2}. All of the other run outcomes are the same as shown in Table 8. On inspecting the logic of C_{3,3}, the reason becomes clear. C_{3,3} has logic that is more restrictive than that of C_{3,2}. While C_{3,2} restricts some connector transferring resources between performed activities to be subject to a rule that constrain both performers, C_{3,3} restricts all connectors transferring resources between performed activities to be subject to rules that constrain both performers. With neither of these constraints in place, resources can be transferred by connectors that are not subject to any rule that constrains both performers, as in FIG. 27, which is a graph 2700 illustrating counterexample for conditions C_{3,2} and C_{3,3}, according to an embodiment of the present invention.

Let C_{3,6}=(C_{3,2} [symbol] C_{3,3}). Substituting the results of this analysis into Equation (6),

[symbol]

C_{3,4}→ [symbol] C₃ Equation (23)

[symbol]

C_{3,5}→ [symbol] C₃ Equation (24)

[symbol]

C_{3,6}→ [symbol] C₃ Equation (25)

C_{3,4}, C_{3,5} and C_{3,6} are therefore necessary conditions for C₃ in M″.

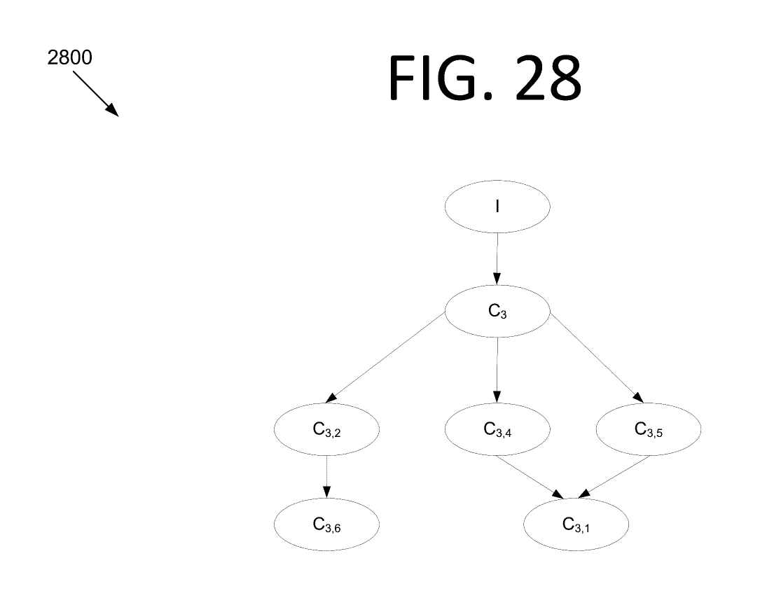

Under the full pairwise test, each interoperability condition in Table 7 is manually inspected against each other condition to see if there is an implication dependency between the pair. The results of the inspection are summarized for model M′″ in FIG. 28. FIG. 28 is a graph 2800 illustrating model M′″ necessary condition for I, according to an embodiment of the present invention.

In graph 2800, C₃ is shown to be necessary for I (from Equation (19)), C_{3,2} is necessary for C₃, C_{3,6} is necessary for C_{3,2}. C_{3,4} is necessary for C₃, and C_{3,5} is necessary for C₃. Finally, C_{3,1} is necessary for both C_{3,4} and C_{3,5}. No other implication dependencies were found on a manual inspection of all the other conditions. These results show dependencies of two conditions on another condition, as the former are more restrictive versions of the latter.

### Axioms and Conditions

Table 10 summarizes the axioms for interoperability of a design between a pair of performers for the AMBIA use case shown in FIG. 4. The axioms were derived from observations made during the model building process and from experience designing interoperable systems.

For Axioms 1-2, the predicates produces( ) and consumes( ) are defined as follows. Given a performer p and a resource r,

produces(p,r)=(∃aεA)[performs(p,a) [symbol] produces(a,r)] Equation (26)

consumes(p,r)=(∃aεA)[performs(p,a) [symbol] consumes(a,r)] Equation (27)

The Third through Sixth Axioms apply only to performers involved in a resource exchange. The exchanges predicate is defined as “p_{A} produces a resource to or consumes a resource from p_{B}”, represented as follows.

exchanges(p_{A},p_{B},r) Equation (28)

TABLE 10
SUMMARY OF AXIOMS

| ID | Axiom | Axiomatic Condition |
|---|---|---|
| 1 | If there exists a performer that produces a | X_{1,1}: For any performer that produces any |
| | resource that is not consumed by any other | resource, there exists some performer that |
| | performer, the design is not interoperable. | consumes that resource. |
| | (∃p _{A} ∈ P)(∃r ∈ R) | (∀p _{A} ∈ P)(∀r ∈ R) |
| | [ produces (p _{A} , r) [symbol] | [ produces(p _{A} , r) → |
| | [symbol] ((∃p _{B} ∈ P)consumes(p _{B} , r)) ] | ((∃p _{B} ∈ P)consumes(p _{B} , r)) ] |
| | → [symbol] I | |
| 2 | If there exists a performer that consumes a | X_{1,2}: For any performer that consumes any |
| | resource that is not produced by any other | resource, there exists some performer that |
| | performer, the design is not interoperable. | produces that resource. |
| | (∃p _{A} ∈ P)(∃r ∈ R) | (∀p _{A} ∈ P)(∀r ∈ R) |
| | [ consumes(p _{A} , r) [symbol] | [ consumes(p _{A} , r) → |
| | [symbol] ((∃ p _{B} ∈ P) produces(p _{B} , r)) ] | ((∃p _{B} ∈ P) produces(p _{B} , r)) ] |
| | → [symbol] I | |
| 3 | If a resource that is exchanged between | X_{2,1}: Every exchanged resource between |
| | any two performers is not transferred by | any two performers is transferred by some |
| | some connector that connects those two | connector that connects those performers. |
| | performers, then the design is not | |
| | interoperable. | |
| | (∃p _{A} , p _{B} ∈ P)(∃r ∈ R) | (∀p _{A} , p _{B} ∈ P)(∀r ∈ R) |
| | [exchanges(p _{A} , p _{B} , r) [symbol] | [exchanges(p _{A} , p _{B} , r) → |
| | [symbol] ( (∃c ∈ C)transferredby(r, c) [symbol] | ( (∃c ∈ C)transferredby(r, c) [symbol] |
| | connects(c, p _{A} ) [symbol] connects(c, p _{B} ) )] | connects(c, p _{A} ) [symbol] connects(c, p _{B} )] |
| | → [symbol] I | |
| 4 | If a resource that is exchanged between | X_{3,1}: Every exchanged resource between |
| | any two performers is not transferred by | any two performers is transferred by some |
| | some connector that both connects those | connector that both connects those |
| | two performers and is subject to some rule | performers and is subject to some rule that |
| | that constrains those two performers, then | constrains those performers. |
| | the design is not interoperable. | |
| | (∃p _{A} , p _{B} ∈ P)(∃r ∈ R) | (∀p _{A} , p _{B} ∈ P)(∀r ∈ R) |
| | [exchanges(p _{A} , p_{B} , r) [symbol] (p _{A} ≠ p _{B} ) [symbol] | [exchanges(p _{A} , p _{B} , r) → |
| | [symbol] ( (∃c ∈ C)transferredby(r, c) [symbol] | ( (∃c ∈ C)transferredby(r, c) [symbol] |
| | connects(c, p _{A} ) [symbol] connects(c, p _{B} ) [symbol] | connects(c, p _{A} ) [symbol] connects(c, p _{B} ) [symbol] |
| | (∃s ∈ S)constrainsc(s, c) [symbol] | (∃s ∈ S)constrainsc(s, c) [symbol] |
| | constrainsp(s, p _{A} ) [symbol] | constrainsp(s, p _{A} ) [symbol] |
| | constrainsp(s, p _{B} ) )] | constrainsp(s, p _{B} ) )] |
| | → [symbol] I | |
| 5 | If some activity a_{A} of some performer p_{A} | X_{3,2}: If any resource produced by any |
| | produces some resource consumed by | activity a_{A} of any performer p_{A} is |
| | some activity a_{B} of some performer p_{B}, and | consumed by any activity a_{B} of any |
| | a_{A} and a_{B} are not subject to at least one | performer p_{B}, then a_{A} and a_{B} are subject to |
| | common rule that also constrains both p_{A} | at least one common rule that constrains |
| | and p_{B}, then the design is not interoperable. | both p_{A} and p_{B}. |
| | (∃p _{A} , p _{B} ∈ P)(∃a _{A} , a _{B} ∈ A)(∃r ∈ R) | (∀p _{A} , p _{B} ∈ P)(∀a _{A} , a _{B} ∈ A)(∀r ∈ R) |
| | [performs(p _{A} , a _{A} ) [symbol] produces(a _{A} , r) [symbol] | [( performs(p _{A} , a _{A} ) [symbol] produces(a _{A} , r) [symbol] |
| | performs(p _{B} , a _{B} ) [symbol] consumes(a _{B} , r) [symbol] | performs(p _{B} , a _{B} ) [symbol] consumes(a _{B}, r) ) → |
| | [symbol] ( (∃s ∈ S)constrainsa(s, a _{A} ) [symbol] | ( (∃s ∈ S)constrainsa(s, a _{A} ) [symbol] |
| | constrainsa(s, a _{B} ) [symbol] | constrainsa(s , a _{B} ) [symbol] |
| | constrainsp(s, p _{A} ) [symbol] | constrainsp(s , p _{A} ) [symbol] |
| | constrainsp(s, p _{B} ) )] | constrainsp(s , p _{B} ) )] |
| | → [symbol] I | |
| 6 | If a resource that is exchanged between | X_{3,3}: Every exchanged resource between |
| | any two performers is not subject to some | any two performers is subject to some rule |
| | rule that also constrains those two | that constrains those performers. |
| | performers, then the design is not | |
| | interoperable. | |
| | (∃p _{A} , p _{B} ∈ P)(∃r ∈ R) | (∀p _{A} , p _{B} ∈ P)(∀r ∈ R) |
| | [exchanges(p _{A} , p _{B} , r) [symbol] | [exchanges(p _{A} , p _{B} , r) → |
| | [symbol] ( (∃s ∈ S)constrainsr(s, r) [symbol] | ( (∃s ∈ S)constrainsr(s, r) [symbol] |
| | constrainsp(s, p _{A} ) [symbol] | constrainsp(s, p _{A} ) [symbol] |
| | constrainsp(s, p _{B} ) )] | constrainsp(s, p _{B} ) )] |
| | → [symbol] I | |

Tables 11 to 13 summarize the conditions discovered during the three implementations of the AMBIA process. These conditions were derived from a conceptual data model of classes and relationships defined in the first step of the process. The AMBIA process elucidated dependencies among each of the conditions below, as well as the axiomatic conditions and I (the collection of axiomatic conditions across all implementations).

TABLE 11
SUMMARY OF CONDITIONS FOR MODEL M′

| ID | Condition |
|---|---|
| G_{1,1} | No activity produces and consumes the same resource. |
| | (∀a ∈ A)( [symbol] ∃r ∈ R)[produces(a, r) [symbol] consumes(a, r)] |
| G_{1,2} | If any activity produces a resource, it also consumes |
| | a resource. |
| | (∀a ∈ A)( ∃r₁ ∈ R)[produces(a, r₁) → (∃r₂ ∈ R) |
| | consumes(a, r₂)] |
| G_{1,3} | All disjoint performers perform disjoint activities. |
| | (∀p _{A} , p _{B} ∈ P)( [symbol] ∃a ∈ A)[p _{A} ≠ p _{B} [symbol] performs(p _{A} , a) [symbol] |
| | performs(p _{B} , a)] |
| G_{1,4} | Each performer performs no more than one activity. |
| | (∀p∈ P)(∀a _{A} ∈ A)[performs(p, a _{A} ) → [symbol] ((∃a _{B} ∈ A)performs(p, |
| | a _{B} ) [symbol] a _{A} ≠ a _{B}))] |
| C_{1,1} | Each activity produces or consumes at least one resource. |
| | (∀a ∈ A)(∃r ∈ R)[produces(a, r) [symbol] consumes(a, r)] |
| C_{1,2} | Each performer performs at least one activity. |
| | (∀p ∈ P)(∃a ∈ A)[performs(p, a)] |
| C_{1,3} | Any resource is produced by some activity. |
| | (∀r ∈ R)(∃a ∈ A)[producedby(r, a)] |
| C_{1,4} | Any resource is consumed by some activity. |
| | (∀r ∈ R)(∃a ∈ A)[consumedby(r, a)] |
| C_{1,5} | Each performer produces a resource to or consumes a |
| | resource from at least one other disjoint performer. |
| | (∀p _{A} ∈ P)(∃p _{B} ∈ P)(∃r ∈ R)[ (produces(p _{A} , r) [symbol] |
| | consumes(p _{B} , r) ) [symbol] |
| | (consumes(p _{A} , r) [symbol] produces(p _{B} , r) ) [symbol] p _{A} ≠ p _{B} ] |
| C_{1,6} | Any activity is performed by some performer. |
| | (∀a ∈ A)(∃p ∈ P)[performedby(a, p)] |
| C_{1,7} | C_{1,3} [symbol] C_{1,4} [symbol] C_{1,6} |

TABLE 12
SUMMARY OF CONDITIONS FOR MODEL M″

| ID | Condition |
|---|---|
| G_{2,1} | Any connector connects no more than two performers. |
| | (∀c ∈ C) ( [symbol] ∃p _{A} , p _{B} , p_{C} ∈ P) |
| | [connects(c, p _{A} ) [symbol] connects(c, p _{B} ) [symbol] |
| | connects(c, p _{C} ) [symbol] (p _{A} ≠ p _{B} ≠ p _{C} )] |
| C_{2,1} | Each performer is connected to at least one connector. |
| | (∀p ∈ P)(∃c ∈ C)connectedto(p, c) |
| C_{2,2} | If any two performers exchange some resource, those |
| | performers are connected to at least one common connector. |
| | (∀p _{A} , p _{B} ∈ P)(∃r ∈ R)[exchanges(p _{A} , p _{B} , r) → |
| | ( (∃c ∈ C)connects(c, p _{A} ) [symbol] connects(c, p _{B} ) )] |
| C_{2,3} | Every exchanged resource between any two performers |
| | is transferred by some connector. |
| | (∀p _{A} , p _{B} ∈ P)(∀r ∈ R)[exchanges(p _{A} , p _{B} , r) → |
| | (∃c ∈ C)transferredby(r, c)] |
| C_{2,4} | Every exchanged resource between any two performers is |
| | transferred by some connector that connects those performers. |
| | (∀p _{A} , p _{B} ∈ P)(∀r ∈ R)[exchanges(p _{A} , p _{B} , r) → |
| | ( (∃c ∈ C)transferredby(r, c) [symbol] |
| | connects(c, p _{A} ) [symbol] connects(c, p _{B} ) )] |
| C_{2,5} | Any connector connects at least two disjoint performers. |
| | (∀c ∈ C)(∃p _{A} , p _{B} ∈ P)[connects(c, p _{A} ) [symbol] |
| | connects(c, p _{B} ) [symbol] (p _{A} ≠ p _{B} )] |

TABLE 13
SUMMARY OF CONDITIONS FOR MODEL M″′

| ID | Condition |
|---|---|
| G_{3,1} | Each performer is subject to some rule. |
| | (∀p ∈ P)(∃s ∈ S)[subjectto(p, s)] |
| G_{3,2} | Each activity is subject to some rule. |
| | (∀a ∈ A)(∃s ∈ S)[subjectto(a, s)] |
| G_{3,3} | Each resource is subject to some rule. |
| | (∀r ∈ R)(∃s ∈ S)[subjectto(r, s)] |
| G_{3,4} | Each connector is subject to some rule. |
| | (∀c ∈ C)(∃s ∈ S)[subjectto(c, s)] |
| C_{3,1} | If any two performers exchange some resource, those performers are subject to |
| | some common rule. |
| | (∀p _{A} , p _{B} ∈ P)(∃r ∈ R)[(produces(p _{A} , r) [symbol] consumes(p _{B} , r) ) → |
| | ( (∃s ∈ S) subjectto(p _{A} , s) [symbol] subjectto(p _{B} , s) )] |
| C_{3,2} | Every exchanged resource between any two performers is transferred by some |
| | connector that both connects those performers and is subject to some rule that |
| | constrains those performers. |
| | (∀p _{A} , p _{B} ∈ P)(∀r ∈ R)[exchanges(p _{A} , p _{B} , r) → |
| | ( (∃c ∈ C)transferredby(r, c) [symbol] connects(c, p _{A} ) [symbol] connects(c, p _{B} ) [symbol] |
| | (∃s ∈ S)constrainsc(s, c) [symbol] constrainsp(s, p_{A}) [symbol] constrainsp(s, p _{B} ) )] |
| C_{3,3} | Every connector that connects any two performers and transfers an exchanged |
| | resource between those performers is subject to some rule that constrains those |
| | performers. |
| | (∀p _{A} , p _{B} ∈ P)[ (∃r ∈ R)exchanges(p _{A} , p _{B} , r) → |
| | [ (∀c ∈ C)( connects(c, p _{A} ) [symbol] connects(c, p _{B} ) [symbol] transfers(c, r) ) → |
| | ((∃s ∈ S)constrainsc(s, c) [symbol] |
| | constrainsp(s, p _{A} ) [symbol] |
| | constrainsp(s, p _{B} )) ] ] |
| C_{3,4} | If any resource produced by any activity a_{A} of any performer p_{A} is consumed by |
| | any activity a_{B} of any performer p_{B}, then a_{A} and a_{B} are subject to at least one |
| | common rule that constrains both p_{A} and p_{B}. |
| | (∀p _{A} , p _{B} ∈ P)(∀a _{A} , a _{B} ∈ A)(∀r ∈ R) |
| | [( performs(p _{A} , a _{A} ) [symbol] produces(a _{A} , r) [symbol] performs(p _{B} , a _{B} ) [symbol] consumes(a _{B} , r) ) → |
| | ( (∃s ∈ S)constrainsa(s, a _{A} ) [symbol] constrainsa(s, a _{B} ) [symbol] |
| | constrainsp(s, p _{A} ) [symbol] constrainsp(s, p _{B} ) )] |
| C_{3,5} | Every exchanged resource between any two performers is subject to some rule |
| | that constrains those performers. |
| | (∀p _{A} , p _{B} ∈ P)(∀r ∈ R)[exchanges(p _{A} , p _{B} , r) → |
| | ( (∃s ∈ S)constrainsr(s, r) [symbol] constrainsp(s, p _{A} ) [symbol] constrainsp(s, p _{B} ) )] |
| C_{3,6} | C_{3,2} [symbol] C_{3,3} |

From the tables above, some of the conditions are identical to axiomatic conditions.

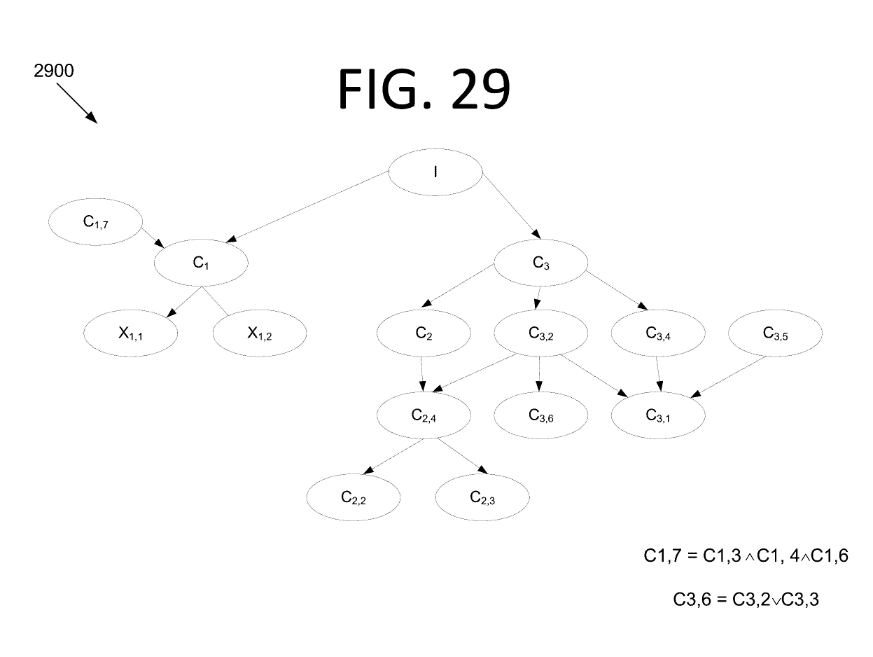

FIG. 29 is a graph 2900 illustrating all necessary conditions, according to an embodiment of the present invention. In particular, graph 2900 summarizes the implication relationships among just interoperability conditions in the form of a logic graph, across all three AMBIA implementations. Additional dependencies are shown for conditions spanning AMBIA implementations (C₃→C₂, C_{3,2}→C_{2,4}). C_{1,7}, though not part of the tree for I, is included to capture the finding gained from the partial test during implementation one.

One skilled in the art will appreciate that a “system” could be embodied as a personal computer, a server, a console, a personal digital assistant (PDA), a cell phone, a tablet computing device, or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology, including cloud computing systems.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, RAM, tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

It will be readily understood that the components of various embodiments of the present invention, as generally described and illustrated in the figures herein, may be arranged and designed in a wide variety of different configurations. Thus, the detailed description of the embodiments of the systems, apparatuses, methods, and computer programs of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

It will be understood that many additional changes in the details, materials, procedures and arrangement of parts, which have been herein described and illustrated to explain the nature of the invention, may be made by those skilled in the art within the principal and scope of the invention as expressed in the appended claims.

1. A computer-implemented method, comprising:
organizing, by a computing system, candidate conditions into a hierarchy of logical expressions; and
determining, by the computing system, whether each child condition is necessary or unnecessary to a condition of a parent.

2. The computer-implemented method of claim 1, further comprising:
receiving, by the computing system, an identified use case in an architecture model for interoperability assessment.

3. The computer-implemented method of claim 1, further comprising:
identifying, by the computing system, a data model subset, wherein
the data model subset comprises at least one class and a set of relationships between elements in a class.

4. The computer-implemented method of claim 3, further comprising:
constraining, by the computing system, the data model subset to assess design characteristics, to expose instances exhibiting a poor general design practice, or both.

5. The computer-implemented method of claim 1, further comprising:
formalizing, by the computing system, axioms to formulate assertions against necessary conditions for interoperability of a design.

6. The computer-implemented method of claim 1, further comprising:
identifying, by the computing system, necessary conditions.

7. The computer-implemented method of claim 6, wherein the identifying of the necessary conditions comprises:
determining, by the computing system, new constraints necessary for interoperability of the design; and
documenting, by the computing system, the new constraints necessary for interoperability of the design.

8. A computer-implemented method, comprising:
receiving, by a computing system, an identified use case in an architecture model for interoperability assessment
organizing, by the computing system, candidate conditions into a hierarchy of logical expressions; and
determining, by the computing system, whether each child condition is necessary or unnecessary to a condition of a parent.

9. The computer-implemented method of claim 8, further comprising:
identifying, by the computing system, a data model subset, and the data model subset comprises at least one class and a set of relationships between elements in a class.

10. The computer-implemented method of claim 9, further comprising:
constraining, by the computing system, instantiations of the data model subset to exclude instances exhibiting a poor general design practice, prevent interoperability for a use case, or both.

11. The computer-implemented method of claim 8, further comprising:
formalizing, by the computing system, axioms to formulate assertions against conditions for interoperability of a design.

12. The computer-implemented method of claim 8, further comprising:
identifying, by the computing system, the conditions for interoperability of the design.

13. The computer-implemented method of claim 12, wherein the identifying of the necessary conditions comprises:
determining, by the computing system, which new constraints are necessary for interoperability of the design.

14. The computer-implemented method of claim 13, wherein the identifying of the necessary conditions further comprises:
documenting, by the computer system, the new constraints necessary for interoperability of the design.

15. A computer-implemented method, comprising:
receiving, by a computing system, a first performer and a second performer to determine interoperability between the first performer and the second performer in a design;
assessing, by the computing system, interoperability between the first performer and the second performer in the design; and
transmitting, from the computing system, results of the assessment for the interoperability.

16. The computer-implemented method of claim 15, wherein the assessing of the interoperability comprises determining, by the computing system, whether there are known aspects that may create issues for interoperability of the design.

17. The computer-implemented method of claim 15, wherein the assessing of the interoperability of the design comprises identifying, by the computing system, classes in an architecture model and relationships between the classes.

18. The computer-implemented method of claim 16, wherein the assessing of the interoperability comprises adding, by the computing system, constraints to the classes and the relationships between the classes to expose instances exhibiting a poor general design practice, to assess design characteristics, or both.

19. The computer-implemented method of claim 18, wherein the assessing of the interoperability comprises formalizing, by the computing system, axioms to formulate assertions against conditions that will be tested for necessity for the interoperability of the design.

20. The computer-implemented method of claim 19, wherein the assessing of the interoperability comprises determining, by the computing system, new constrains necessary for interoperability of the design.
